(19) United States
(12) Patent Application Publication
(10) Pub. No.: US 2006/0224631 A1
(43) Pub. Date: Oct. 5, 2006

(54) System and method for using graphic and text data of Korean American families to enhance Korean American networking

(76) Inventor: Daewon Kwon, Los Angeles, CA (US)

Correspondence Address: CHRISTIE, PARKER & HALE, LLP, PO BOX 7068, PASADENA, CA, 91109-7068, US

(21) Appl. No.: 11/398,209

(22) Filed: Apr. 4, 2006

Related U.S. Application Data
(60) Provisional application No. 60/668,808, filed on Apr. 5, 2005.

(51) Int. Cl. G06F 17/00

(52) U.S. Cl. 707/104.1

(57) ABSTRACT

A system and method for performing one or more of the following is provided: a) centralized Korean American family networking; b) information entering/viewing/editing a nucleus family member data; c) masking of selected data fields for privacy protection from public; d) method of linking nucleus families; e) search and display method of selected nucleus family tree; f) interface and use of family bulletin; g) use of member Korean American News/Forum; h) method of Korean American Networking; i) application support through Bon-Kwan (family origin name); j) linkage to Korean genealogy in Korea; and k) use of Korean American History.

### CROSS-REFERENCE TO RELATED APPLICATION

This application claims priority to and the benefit of U.S. Provisional Patent Application No. 60/668,808 entitled “System and Method for Using Graphic and Text Data of Korean American Families to Enhance Korean American Networking” and filed Apr. 5, 2005, the entire content of which is incorporated by reference herein.

### FIELD OF THE INVENTION

The present invention relates to a system and method for family tree/genealogy generation, search and networking system. More particularly, the present invention relates to an Internet website based family tree/genealogy database system for a group, where members of the group can save, retrieve, communicate amongst themselves about their family information and read about related information such as the history of the group.

### BACKGROUND OF THE INVENTION

Korean Americans make up a strongly homogeneous ethnic minority group in the United States. The population of the Korean Americans in the United States was 1,076,872 in 2000 according to the 2000 U.S. Census data. When those with mixed heritage is included, this figure becomes 1,229,427. Many Korean Americans live in large cities, especially in Southern California. However, Korean Americans are also very widely spread out in small and medium sized cities and some live in remote areas in the United States. Except for a very small number of Korean Americans, most Korean Americans came to the United States after 1970. Therefore, most Korean American families in the United States can trace their heritage from current first generation.

Korean Americans are a minority group with distinctive Asiatic physical features and a strong cultural heritage. Since Korean Americans are a small minority group, Korean Americans who lives in the area where small number of Korean Americans live, generally find it difficult to interact with other Korean Americans.

Currently available genealogy systems are focused on finding one's ancestors. Korean American do not have ancestors in the United States, except for very small number of Korean Americans. Even for those few people, family history starts from around 1903. Therefore, Korean Americans do not need to search for their ancestors very far into the past.

Koreans have a very advanced genealogy documentation system, which can be used to trace roots going back to the origin of the family. Some families can trace their family history back to thousands of years. However, those genealogy documents are in the format of traditional Korean genealogy based on male head of family and their status in society.

Another major difference of Korean Americans compared to other ethnic groups in the United States is Korean family names. Koreans have only 256 known family names, among which four most common family names constitute 45% of the population in Korea, and 20 most common family names constitute 85% of the population according to 1998 Korean census. In addition, Korean Americans have been adopting many common first names in English such as John or Peter. In addition, different Korean family names may have the same spelling in English. Further, brothers and sisters may adopt different English spellings for the same family name. Therefore, it is desirable to provide a genealogy system which is able to sort through inherent confusions originating from converting the family names to English.

Another difference for Koreans is that a Korean family typically has “Bon-Kwan” which means “family origin name”. The Bon-Kwan is used in Korean genealogy context. The Bon-Kwan may show up in official Korean documents, for example. The Bon-Kwan can be used to separate families from other families that share an identically spelled Korean family name.

### SUMMARY OF THE INVENTION

In an exemplary embodiment according to the present invention, an on-line family tree database system is provided. The on-line family tree database system includes one or more family trees, each family tree including one or more members, the family trees being linkable to each other to form a family tree network, wherein the system allows said one or more members of each family tree to selectively link to other said one or more family trees; and a database of one or more files that are pertinent to the members of the family trees according to at least one of ethnicity, religion or culture.

In another exemplary embodiment according to the present invention, a method of creating a family tree network in a family tree database system is provided. The method includes creating a family tree; and selectively linking the family tree to one or more other family trees.

In yet another exemplary embodiment according to the present invention, a family tree database system includes means for creating a family tree comprising one or more members; and means for selectively linking the family tree to one or more other family trees.

These and other aspects of the invention will be more readily comprehended in view of the discussions herein and accompanying drawings.

### BRIEF DESCRIPTION OF THE DRAWINGS

FIG. 1 is a flow diagram illustrating an operation of a home page, which is first seen when the user accesses a genealogy web site (e.g., KAFT.NET) in an exemplary embodiment of the present invention;

FIG. 2 is a flow diagram illustrating a process of registering as a member;

FIG. 3 is a flow diagram illustrating actions that a member can perform after registering;

FIG. 4 is a flow diagram illustrating a process of viewing a family tree;

FIG. 5 is a flow diagram illustrating a process of editing a family tree;

FIG. 6 is a flow diagram illustrating a process of updating registered member information;

FIG. 7 is a flow diagram illustrating a process of updating family member information;

FIG. 7A is a flow diagram illustrating a process of displaying family member information;

FIG. 7B is a flow diagram illustrating a process of displaying registered member information;

FIG. 8 is a flow diagram illustrating a process of performing a personal member search;

FIG. 9 is a flow diagram illustrating a process of using a Korean American (KA) News/Forum function;

FIG. 10 is a flow diagram illustrating a process of performing KA Networking;

FIG. 11 is a flow diagram illustrating a process of viewing KA history files;

FIG. 12 is a flow diagram illustrating a process of logging in using a password;

FIG. 13 is a flow diagram illustrating a process of using a family bulletin;

FIG. 14 is a flow diagram illustrating a process of performing an access management for a family tree;

FIG. 15 is a flow diagram illustrating a process of requesting access;

FIG. 16 is a flow diagram illustrating a process of registering after viewing a membership agreement;

FIG. 17 is a screen shot of a Korean American Family Tree home page in one exemplary embodiment according to the present invention;

FIG. 18 is a screen shot of a registration page in one exemplary embodiment according to the present invention;

FIG. 19 is a screen shot of a registered member main page in one exemplary embodiment according to the present invention;

FIG. 20 is a screen shot of a family tree chart view page in one exemplary embodiment according to the present invention;

FIG. 21 is a screen shot of a family tree editing page in one exemplary embodiment according to the present invention;

FIGS. 22A and 22B are screen shots of a family tree access management page in one exemplary embodiment according to the present invention;

FIG. 23 is a screen shot of a registered member detail page in one exemplary embodiment according to the present invention;

FIG. 24 is a screen shot of a registered member information page in one exemplary embodiment according to the present invention;

FIGS. 25A and 25B are screen shots of an edit family member page in one exemplary embodiment according to the present invention;

FIG. 26 is a screen shot of a family member information page in one exemplary embodiment according to the present invention;

FIG. 27 is a screen shot of a Korean-American People Search page in one exemplary embodiment according to the present invention; and

FIGS. 28A-28I are screen shots of KA networking related pages in an exemplary embodiment according to the present invention.

### DETAILED DESCRIPTION

In exemplary embodiments of the present invention, a family tree/genealogy system, which may be referred to as a “family tree system”, “family tree database system” or a “database system” herein, is provided. The family tree system provides one or more of updating genealogy/family information, database searching, communications and networking capabilities to the members over the Internet, especially any such system for Korean-Americans or any other ethnic groups. While using the family tree system, the members can choose to mask certain information that they enter from being viewed by other members and/or by the general public.

The family tree system can be used for one or more of the following purposes: a) to provide linkage between Korean Americans and ancestors in Korea; b) to provide a method of recording legacies of Korean Americans for future generations; c) to promote dialogue and networking among Korean Americans; and d) to teach young Korean Americans what their heritage is. Using the family tree system of the present invention, Korean Americans may find their heritage, identity, and may leave their legacy to their children. This way, Korean Americans may be able to work together with their identity and contribute positively to the well being of the United States.

By way of example, the family tree system in exemplary embodiments of the present invention may enable Korean Americans to easily record and search their family records with privacy protection, thereby allowing them to compile, save and/or search the legacy of Korean-American family members. A Korean American can be defined as a member of a Korean American family. For example, a non-Korean ethnic member, who is married to a Korean American, is a Korean American family member for the purposes of the present invention.

In particular, the family tree system in exemplary embodiments of the present invention may have/provide one or more of, but is not limited to, the following features: 1) allow Korean-Americans to reflect on their parents and their experience and leave their thoughts and footprints as permanent records. This way, future generation Korean Americans can reflect on their family history; 2) permanently save the most reliable and complete text and graphic data of Korean American families, and enable users to search family/personal history as well as case history that may be tied to family data; 3) provide a “family bulletin”, which is an easy way to communicate written notes and pictures to geographically remote family members, relatives and friends; 4) facilitate opportunities for Korean Americans to make friends all over the world through “KA Friend Link” features; 5) allow members to find out their family origins in the United States, and to discover other family members, relatives and friends in the United States; 6) access family data of generations of Korean Americans by linking nucleus family data, thereby making it easier for Korean Americans to find their identity; 7) make it easy to find their ancestors, relatives, friends, and people who made contribution to society and/or the legacy they left in the United States as well as in Korea/Korean history; 8) provide research materials for Korean American history; 9) help Korean Americans to work not only within their own community, but also with other diverse peoples to create a better future; 10) offer interested parties easy access to reliable permanent text as well as graphic databases; 11) assist members who desire to record and/or create their own book of family genealogy; and 12) bring forth news and opinions related to important Korean-American issues.

In an exemplary embodiment according to the present invention, an Internet website based Korean American database system is provided. Using this database system, any Korean American and related family members can save, retrieve, communicate among Korean Americans about their family information, and read about related information such as Korean American history and/or Korean American News/Forum. The Korean American history and the information in Korean American News/Forum may be stored permanently.

Using the database system according to exemplary embodiments of the present invention, a user may build a nucleus family tree, and link the nucleus family tree to other nucleus family trees to create a larger family tree network. The database system may include more than traditional genealogical data. The database system may assure privacy of each family member data by user's option. By way of example, the database system may provide a selective data masking function. The Korean American database system may include features that enhance the family tree functions such as Korean American (KA) Family Bulletin, KA Networking, KA Forum, KA History, Korean Genealogical information, KA family name reference and the like.

The database system provides for a specific procedure and format of entering family member information; a specific way to search and edit/view family member information; a specific way to provide text and/or graphic data communication among family members and friends; a specific way to network among Korean Americans; a specific way to provide Korean American News/Forum; and/or a specific way to provide Korean American history.

The database system may also provides for a member controlled specific method of masking (protecting) privacy of member data from public.

The database system may also define format and type of individual family member data, wherein the family member data may include text as well as picture data.

The database system may also provide for a visual representation of a nucleus family, such as, for example, husband and wife, their parents, and their children and the way they are linked.

The database system may also provide for a method to link with other nucleus family tree chart of an ascending and/or descending family line such as father or children, thereby enabling the user to reach any member of the family line.

The database system may also provide for a method of linking with genealogically remote family members and/or friends.

The database system may also provide for a method for linking/de-linking of nucleus families, which can be prepared by a) invitation, b) approval, c) block, and/or d) cancel functions.

The database system may also provide for a method to position and display style of specific member information (text and graphic) and the way to open the data file.

The database system may also provide a style and size of personal history and comment fields for detailed information storage. The user may also be able to adjust the style and/or size of these fields.

The database system may also provide a search process and user interaction method to locate the searched person among many identical names.

The database system may also provide a system structure of “Family Bulletin” and a method of using such Family bulletin. The database system may also provide a system structure of “Korean American News/Forum” and a method of using such Korean American News/Forum.

The database system may also provide a system structure of “Korean American Networking” and a method of using such Korean American Networking.

The database system may also provide a method of applying Bon-Kwan (family origin name) information to the family tree. The database system may also be able to be used for linking the Korean American family tree to Korean genealogy data in Korea. The database system may provide for an application of Korean American History files.

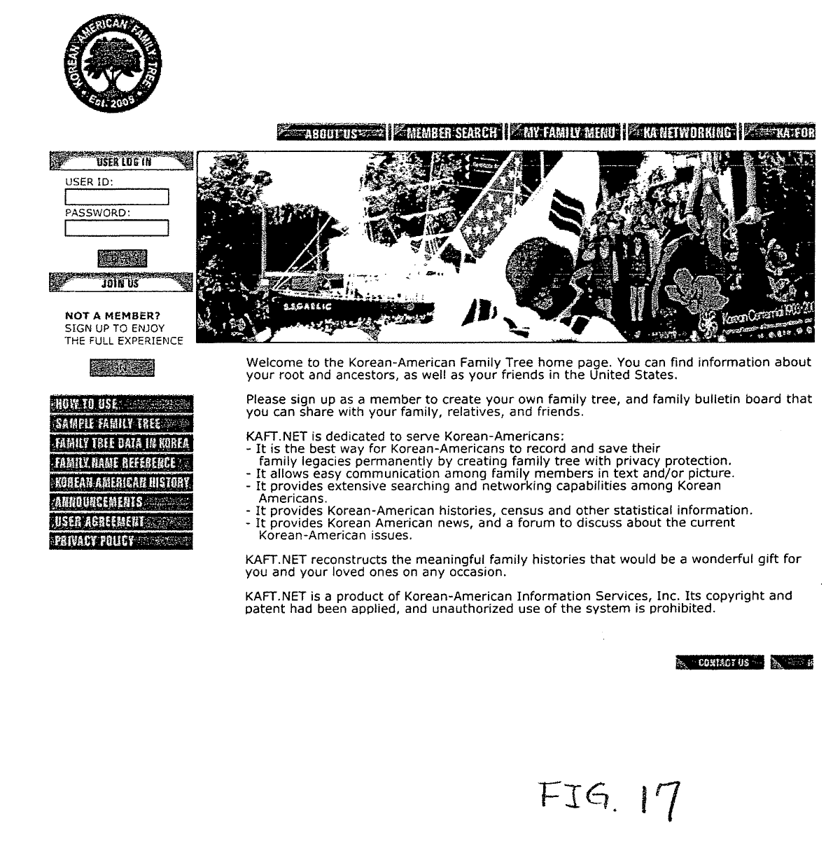

In the flow diagram of FIG. 1, KAFT.NET home page operation is illustrated. Upon accessing/entering web site (10), the home page is displayed (12). The home page displays one or more user selectable options as illustrated in FIG. 17, which is a screen shot of a Korean Family Tree home page (e.g., home page of KAFT.NET) in one exemplary embodiment. By way of example, one of these options may be selected by clicking on a corresponding button using a mouse.

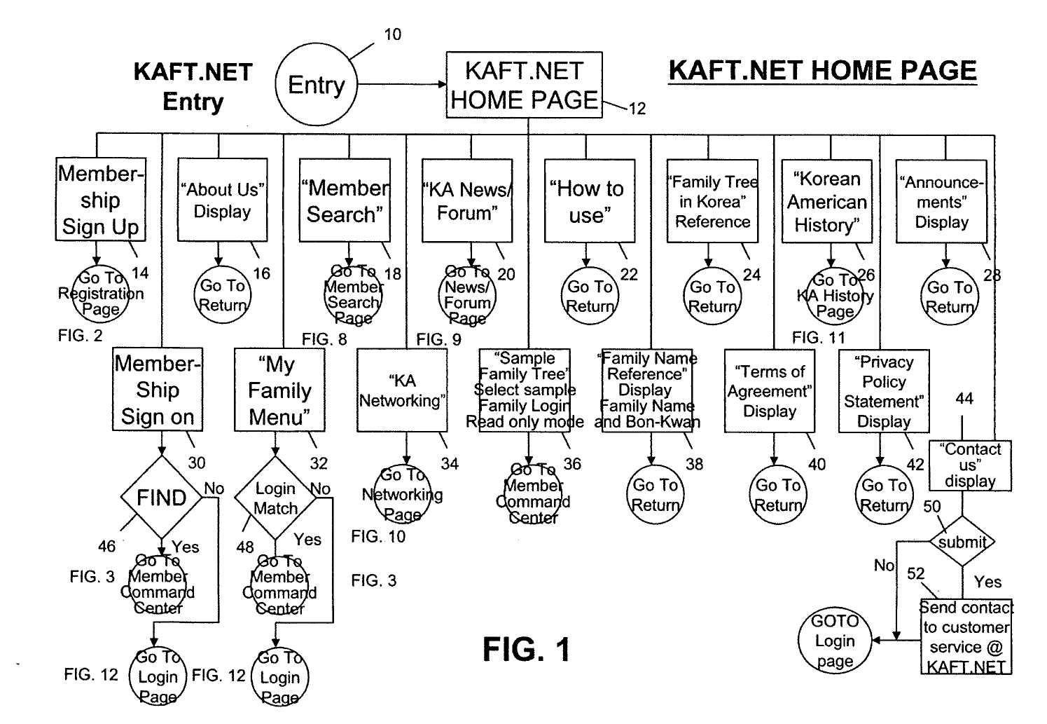

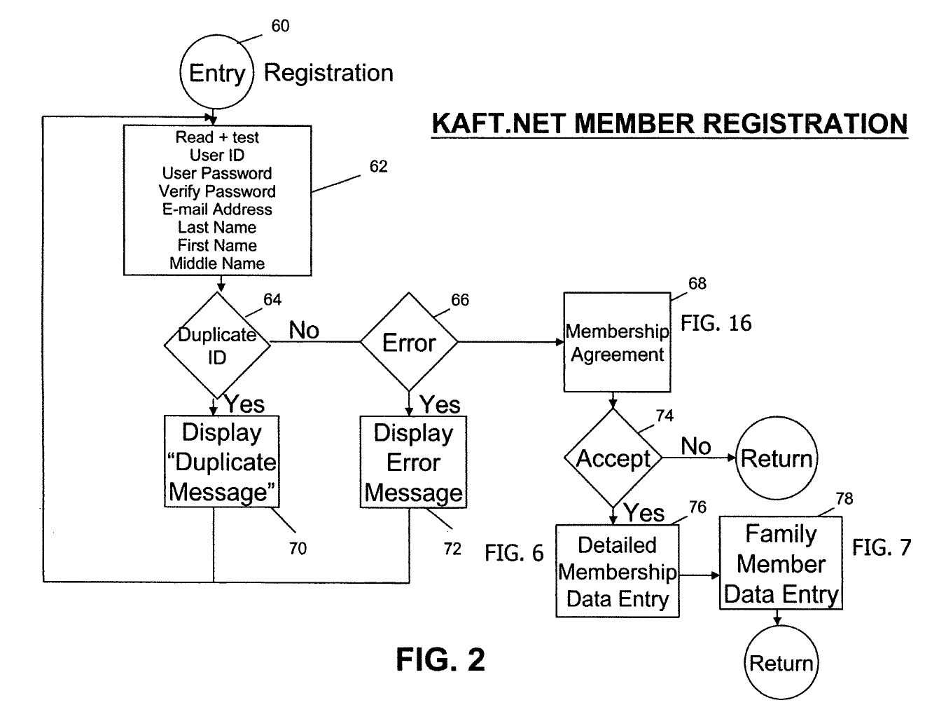

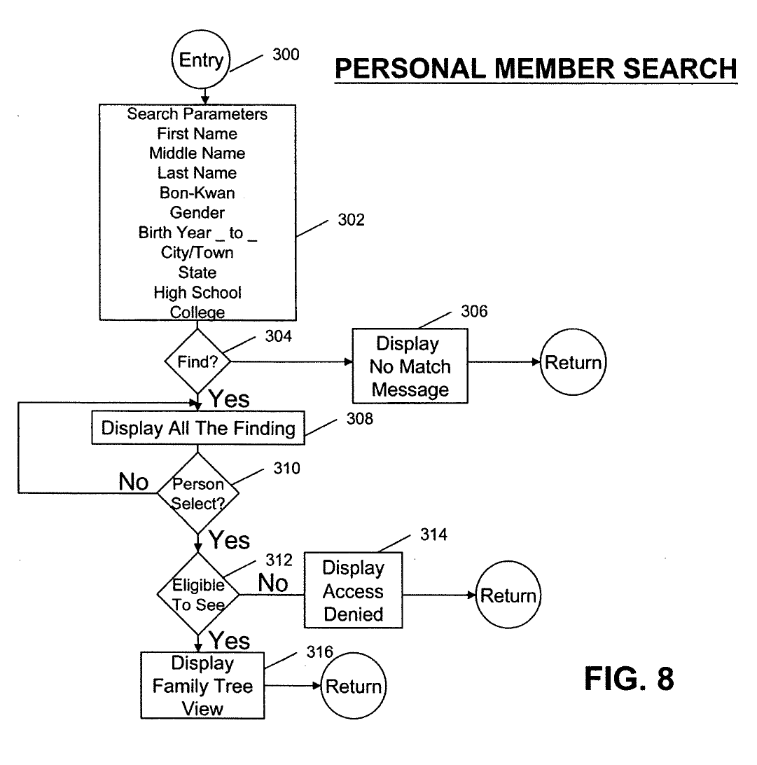

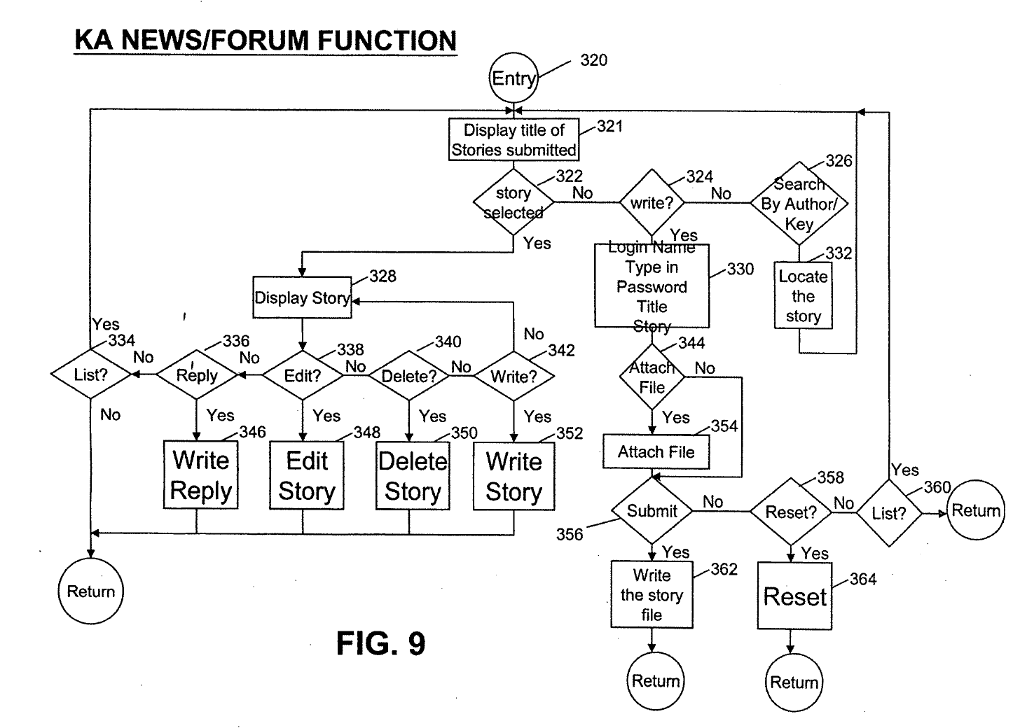

By selecting membership sign up option 14, the registration page can be accessed, the process for which is illustrated in FIG. 2, for example. The “About Us” display option 16 allows the user to view a webpage describing KAFT.NET, for example. By selecting the member search option 18, the user can go to a member search page, the process for which is illustrated in FIG. 8, for example. By selecting the KA News/Forum option 20, the user can go to a new/forum page, the process for which is illustrated in FIG. 9, for example.

The user may view “how to use” by selecting the how-to-use option 22, or read “Family Tree in Korea” reference, “Korean American History” or “Announcements”, respectively, using “Family Tree in Korea” reference option 24, Korean American History option 26, and Announcement display option 28.

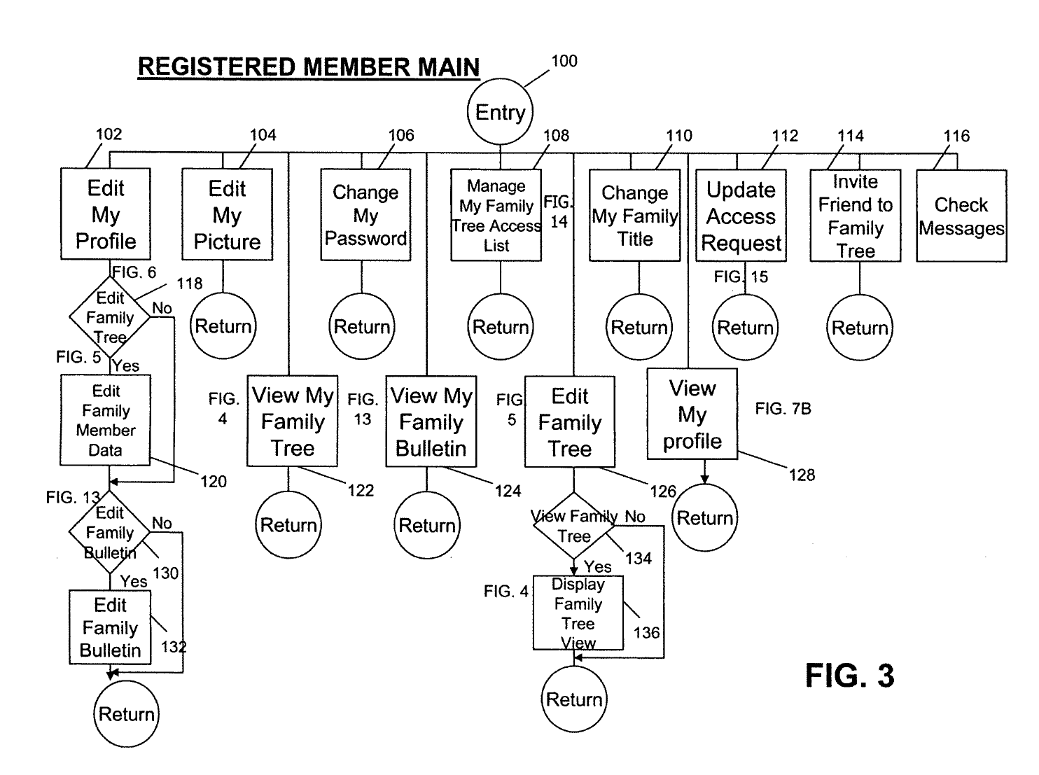

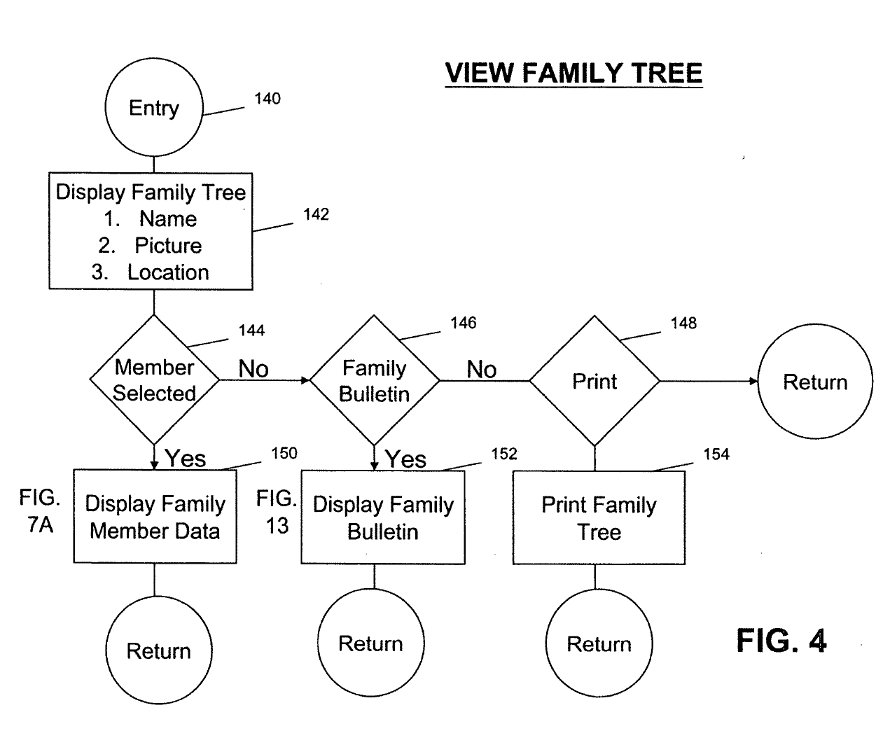

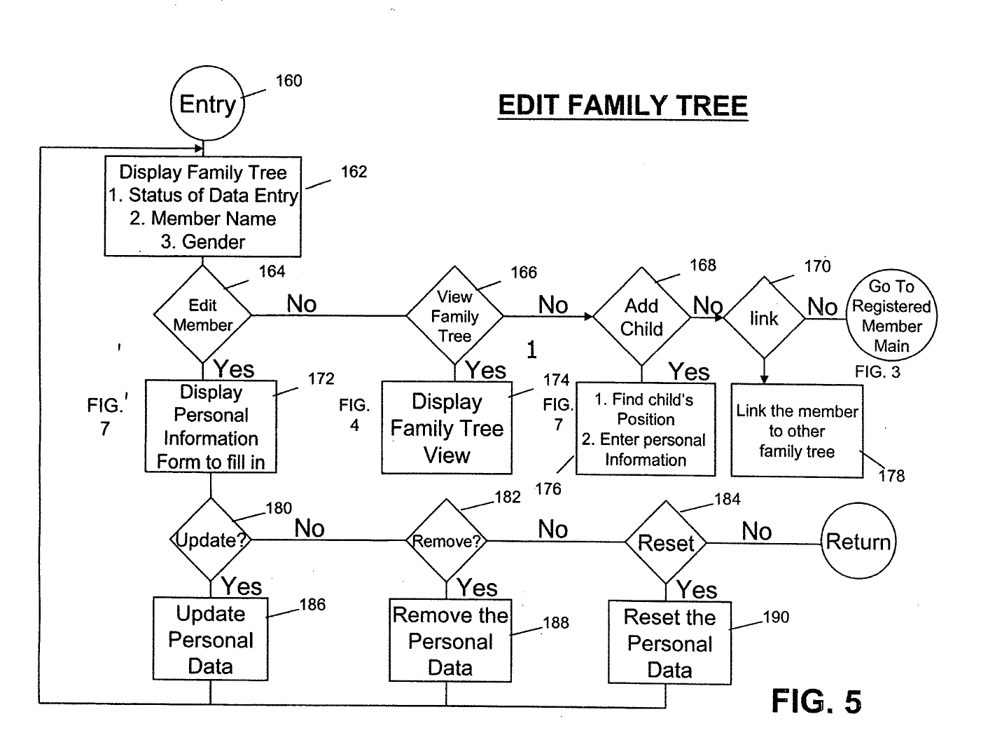

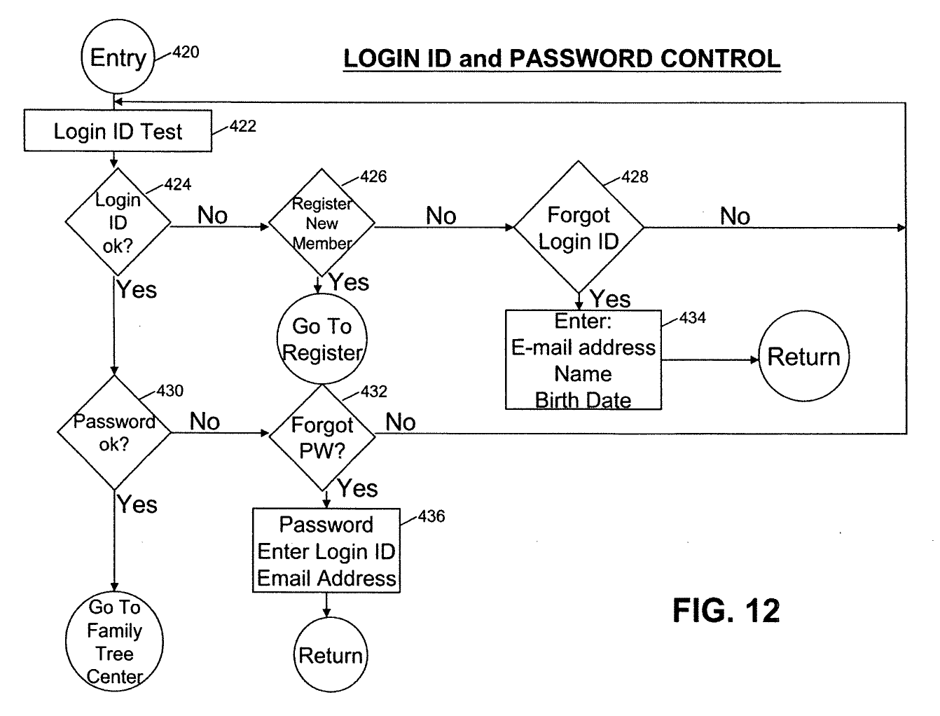

The user may sign up for membership or login using membership sign on option 30. As can be seen on FIG. 17, an implemented embodiment of the family tree system of the present invention, a normal action for the registered members to access the web site beyond the home page is to enter User ID and Password. For those who are not members of the family tree system yet, a “SIGN UP” button is provided for a new member to register. If the member name is found (46), the user may proceed to member command center page, the process for which is illustrated in FIG. 3, for example. If not, the user is directed to a login page, the process for which is illustrated in FIG. 12, for example.

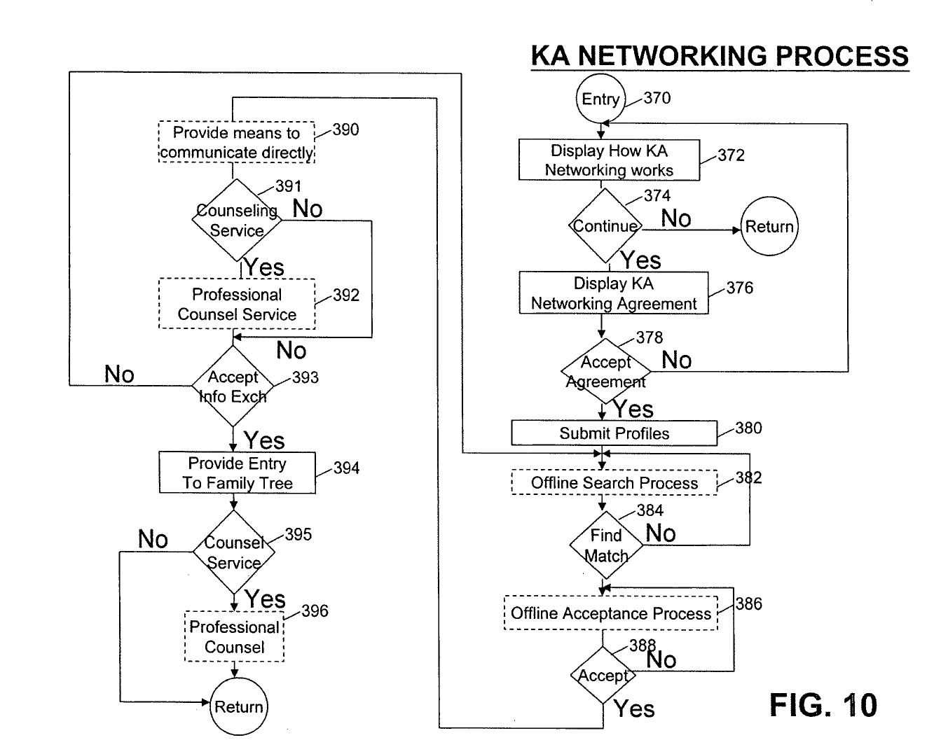

On the home page, “My Family Menu” and “KA Networking” functions do require User ID and Password. When a user attempts to view “my family menu” 32, and there is a login match (48), the user can access the member command center page (see FIG. 3, for example). If not, the user is directed to the login page. The Korean American Family Tree home page may also allow the user to access Korean American (KA) Networking 34, the process for which is illustrated in FIG. 10, for example.

The Korean American Family Tree home page may also allow the user to access the member command center to view “Sample Family Tree” in read only mode (36), view “Family Name Reference” Display including family name and Bon-Kwan 38, view “Terms of Agreement” (40), and/or view “Privacy Policy Statement” (42). The user may also select “Contact Us” display 44, and submit (50) to send a contact request, for example, to customer service at KAFT.NET.

Hence, in the described embodiment, the features that a user can access (e.g., by clicking on buttons) through the home page may include five main functions. The five main functions are: a) Family data entry/view/edit; b) Family member search; c) Korean American Networking; d) Korean American News/Forum; and e) Family Member Bulletin To assist the users, the user may also have access to nine buttons to view reference pages as follows: i) “About us” describes/explains the family tree database system (e.g., KAFT.NET); ii) “How to Use” page briefly explains various aspects of the web site to guide the user to effectively use the family tree system functions; and iii) “Sample Family Tree” will show sample family tree chart and its links to one or more other family trees. Users can display family member text data to see how a nucleus family information is constructed. User can also see a sample family tree and/or bulletin to become familiar with the family tree system (e.g., KAFT.NET).

iv) “Family Name Reference”: Koreans have many identically spelled family names and identical first names. Further some family members have different English spellings for the same Korean name. To reduce the confusion, the “Name Reference” lists all the known English spelling of Korean family names and Bon-Kwan (family origin name) to distinguish between genealogically different families with names that are spelled the same. Hence, this reference is provided to help users identify correct names from a confusing array of different English spellings for the same name, and different Bon-Kwans.

v) “Korean American History”: This section is constructed in file format, and introduces articles and brief summary of important writings about Korean American history. By way of example, a brief summary of important writings about Korean American history is introduced.

vi) “Family Tree Data in Korea” describes how to trace genealogy data in Korea, and how to obtain the member's own genealogy book from Korea. By way of example, it explains how to obtain one's family tree data in Korea, and how to obtain one's own individualized family tree book.

vii) “Announcements” feature provides information of the family tree system (e.g., KAFT.NET) for the members/users to see. By way of example, the “Announcements” feature is provided to inform users what is taking place at the family tree system. viii) “Terms of Service” agreement describes the terms of agreement between a member and KAFT.NET. Finally,

ix) “Privacy statement” is KAFT.NET privacy policy statement and member's agreement with KAFT.NET regarding to the member's privacy issues.

Of course, a home page of the family tree system in other embodiments may have more or less features, functions or buttons than illustrated in FIG. 1 and/or shown in FIG. 17. By way of example, a home page may include other features and functions in addition to all of the functions and features of the above described KAFT.NET.

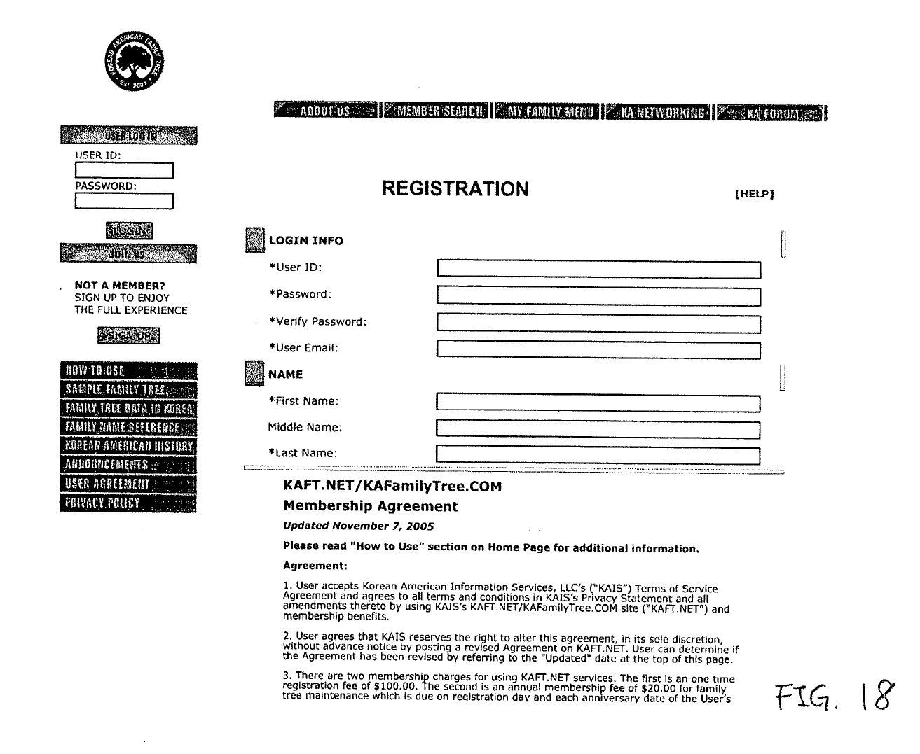

As illustrated in the KAFT.NET member registration flow diagram of FIG. 2, the user registers through entering (60) the registration page. A screen shot of the registration page in one exemplary embodiment is shown in FIG. 18. FIG. 18 also shows a portion of the Membership Agreement. The entire Membership Agreement is not essential to understanding the present invention, and is not enclosed herewith.

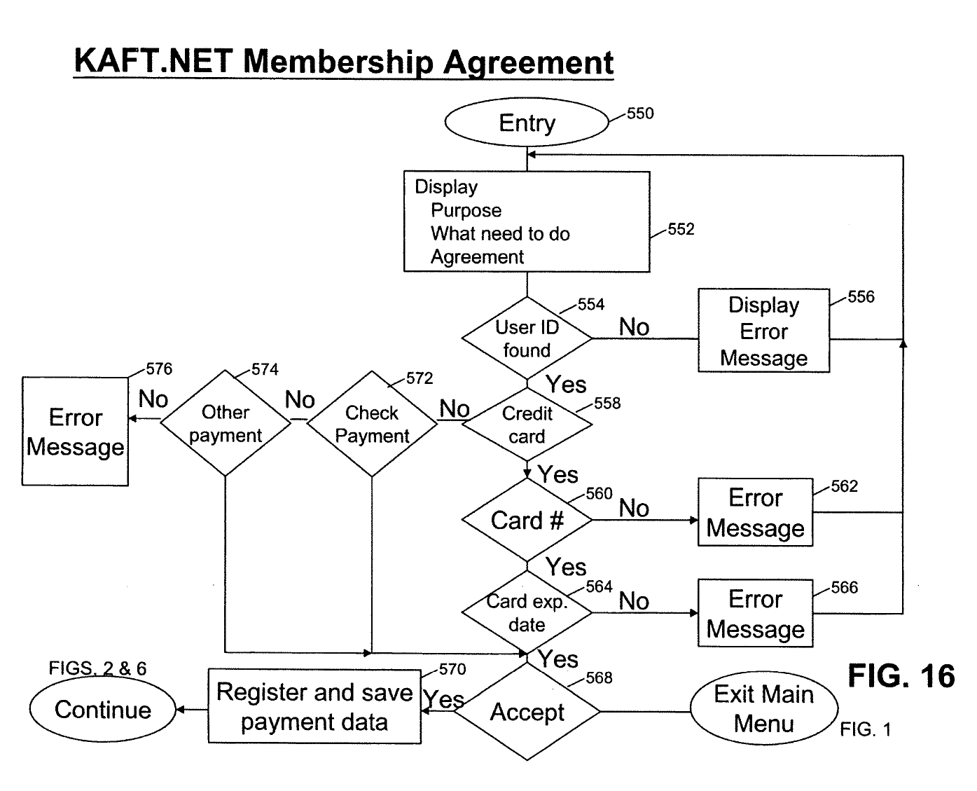

Referring back to FIG. 2, the user may enter one or more of User ID, User Password, Verify Password, E-mail Address, Last Name, First Name and Middle Name (62). If the requested ID is a duplicate (64), a duplicate ID message is displayed to inform the user that the ID is a duplicate ID (70). Also, if there is an error (66), an error message is displayed (72). If there is no duplicate ID or error, the user is requested to accept the Membership Agreement (68). The process of registering as a member in one exemplary embodiment is illustrated in FIG. 16, for example.

According to the process illustrated in FIG. 2, if the user does not accept the membership agreement (74), no further process is performed. If the user accepts the membership agreement (74), however, the user is prompted to enter detailed membership data (76), the process for which is illustrated in FIG. 6, for example. Further, the user may enter family member data (78), the process for which is illustrated in FIG. 7, for example.

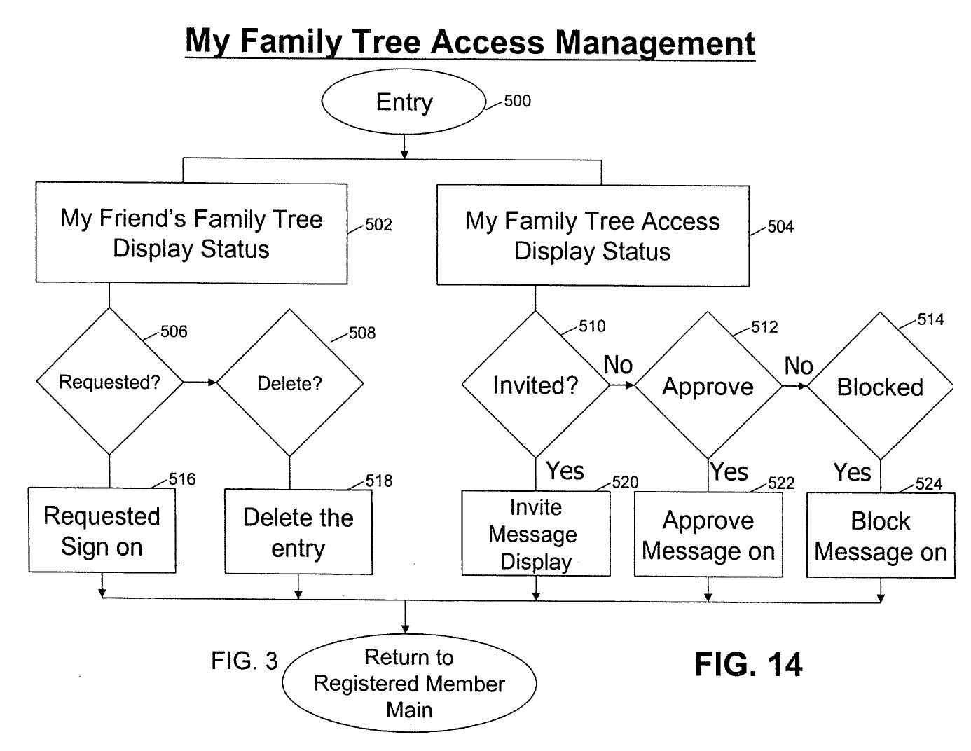

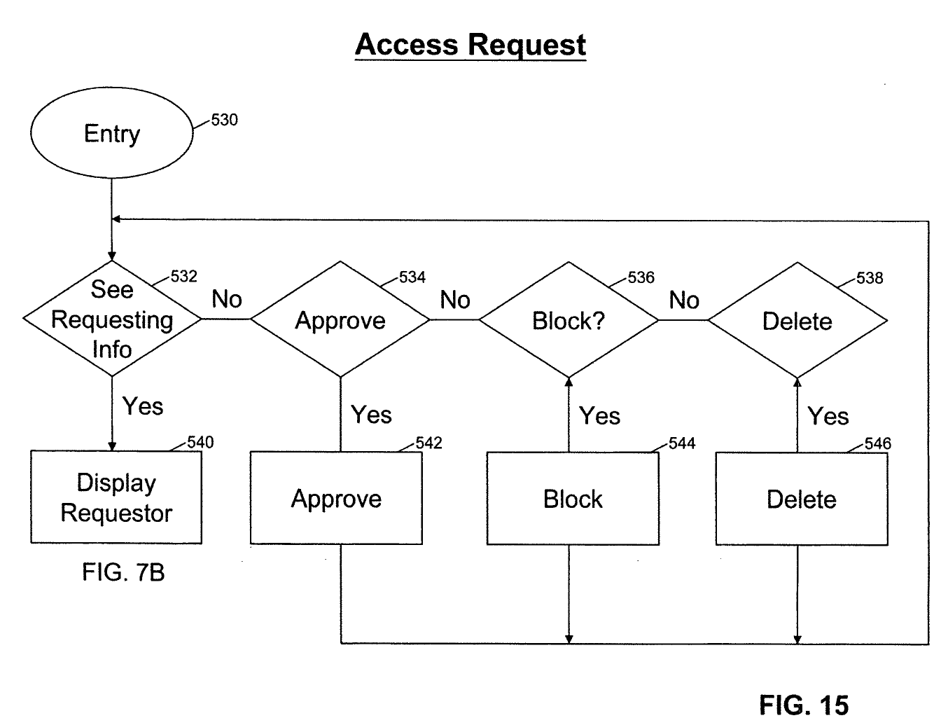

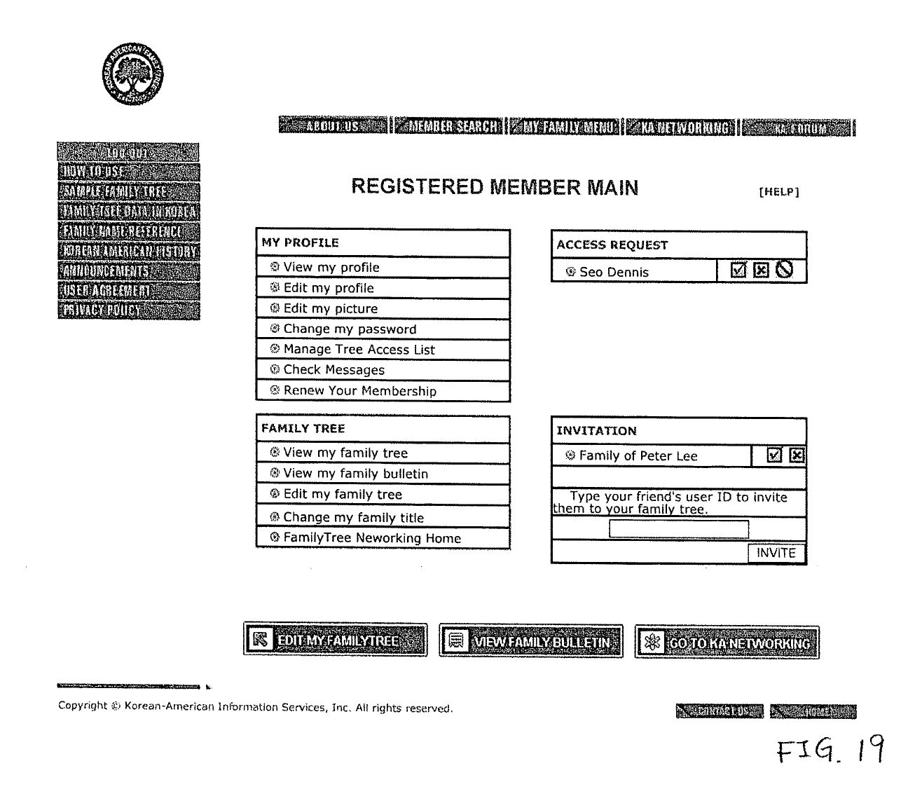

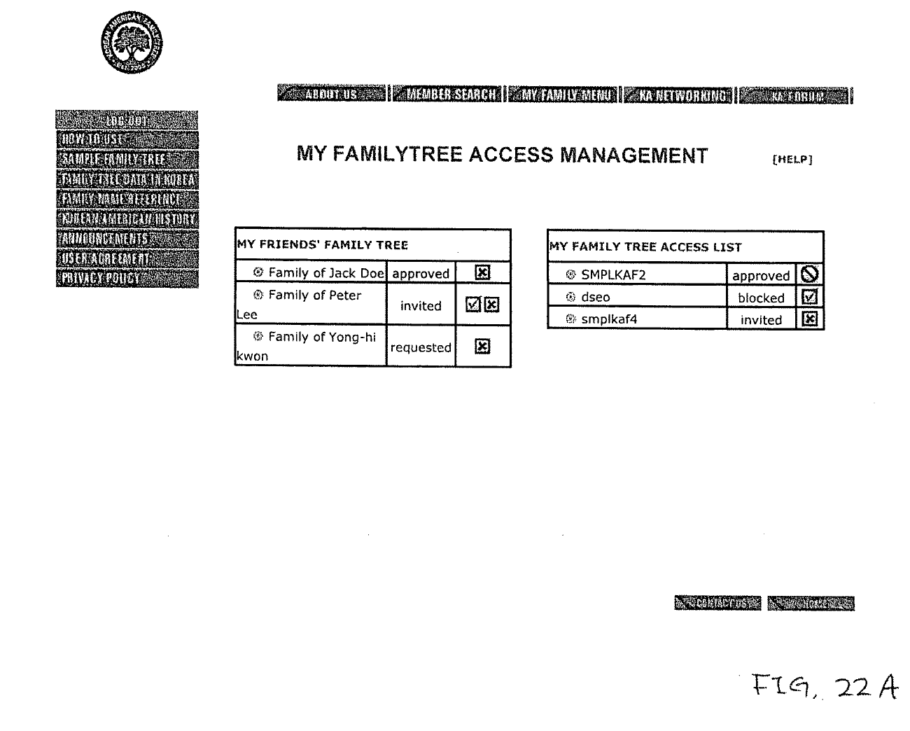

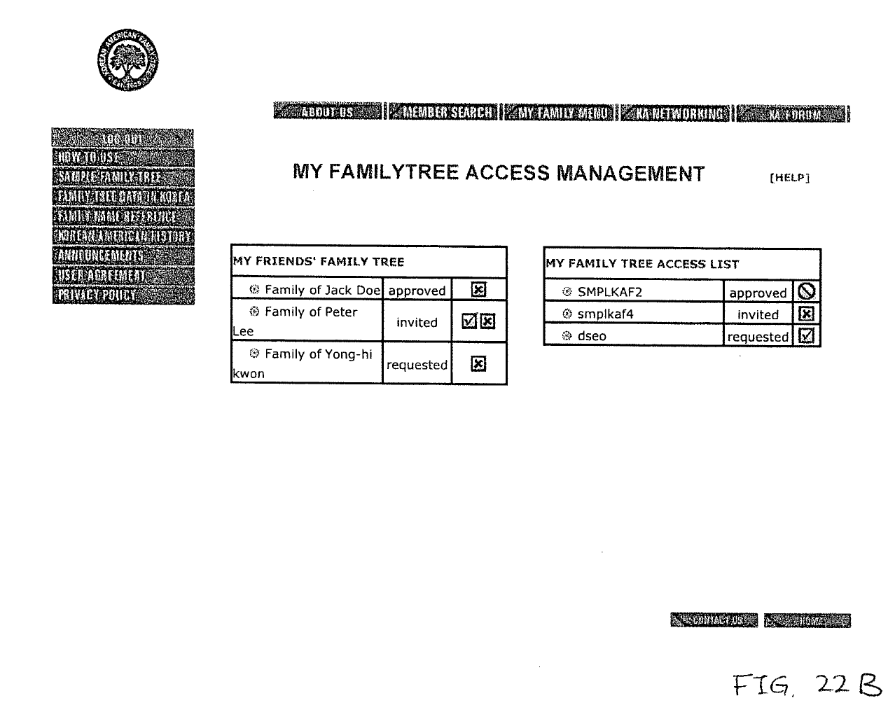

As illustrated in FIG. 3, once the registered member main page is entered (100), the user may edit profile (102), the process for which is illustrated in FIG. 6 for example, edit picture (104), view family tree (122), change password (106), view family bulletin (124), manage family tree access list (108), the process for which is illustrated in FIG. 14 for example, edit family tree (126), change family title (110), view profile (128), the process for which is illustrated in FIG. 7B for example, update access request (112), the process for which is illustrated in FIG. 15, for example, invite friend to family tree (114) and/or check messages (116). FIGS. 19 and 22A,B are screen shots that correspond to the flow diagrams of FIGS. 14 and 15.

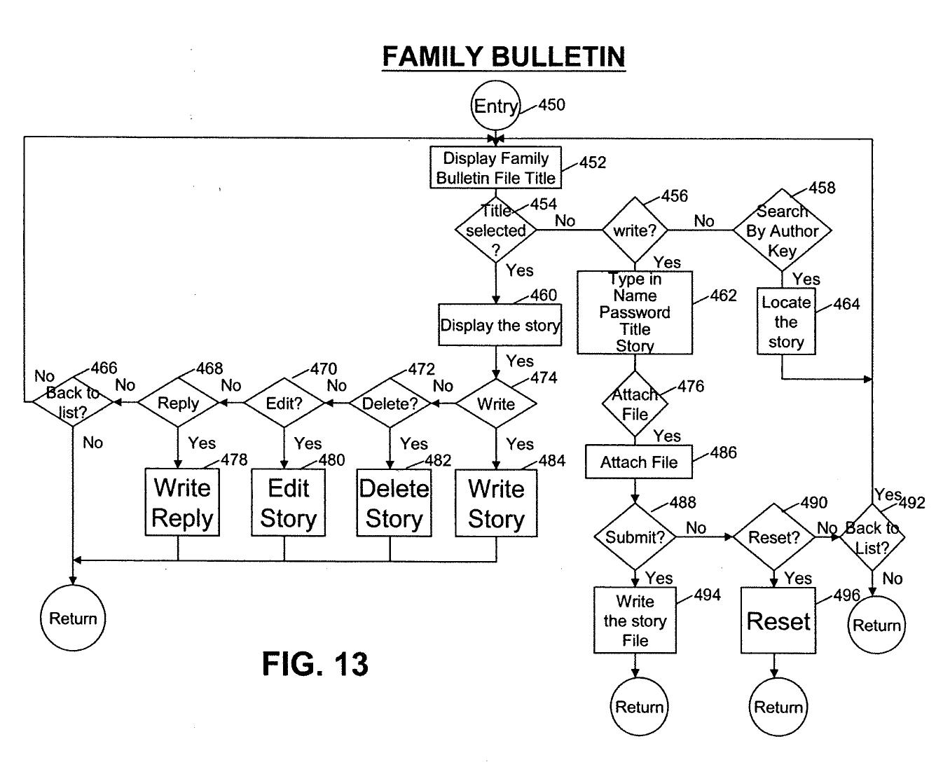

When the user chooses to edit profile (102), the user may edit family tree/family member data (118, 120), the process for which is illustrated in FIG. 5 for example, and/or edit family bulletin (130, 132), the process for which is illustrated in FIG. 13 for example. When the user selects to edit family tree (126), the user may also view family tree (134, 136) whether edited or not.

In one exemplary embodiment, a family tree may be entered only with individualized User ID and Password key. However, a user may created a key “Friend” to enter family tree for view only for a temporary basis for another KAFT.NET member as can be seen in FIG. 3, for example. A user can view other family tree by clicking Access Management Friend's Family Tree or clicking link flag from View Family Tree window.

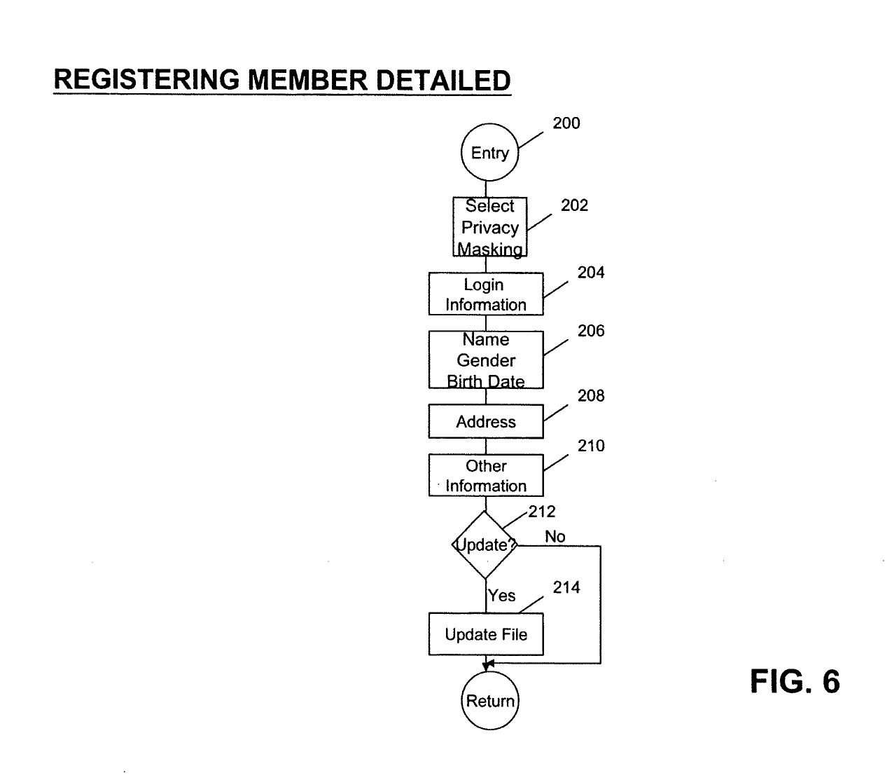

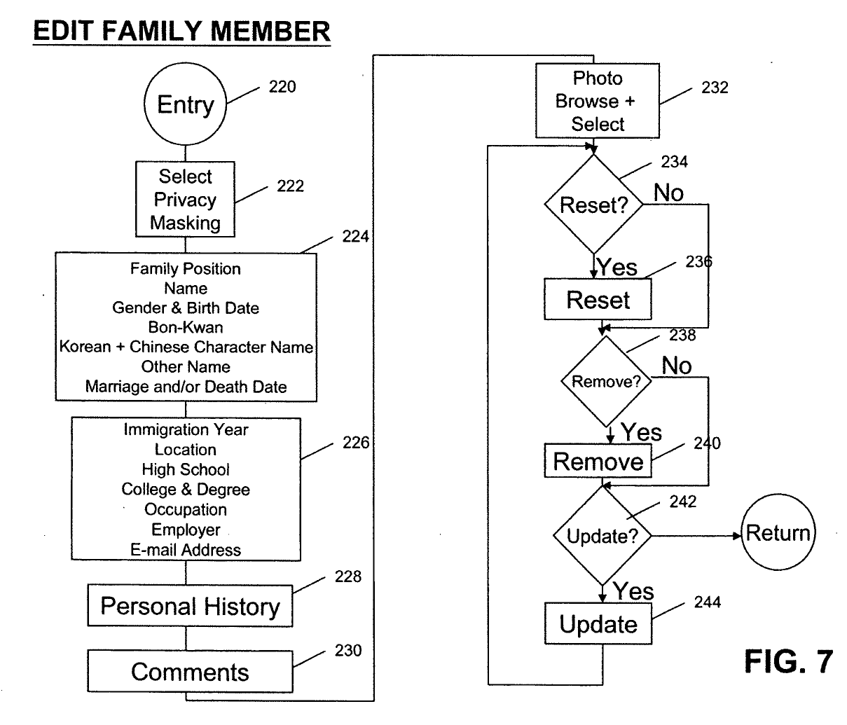

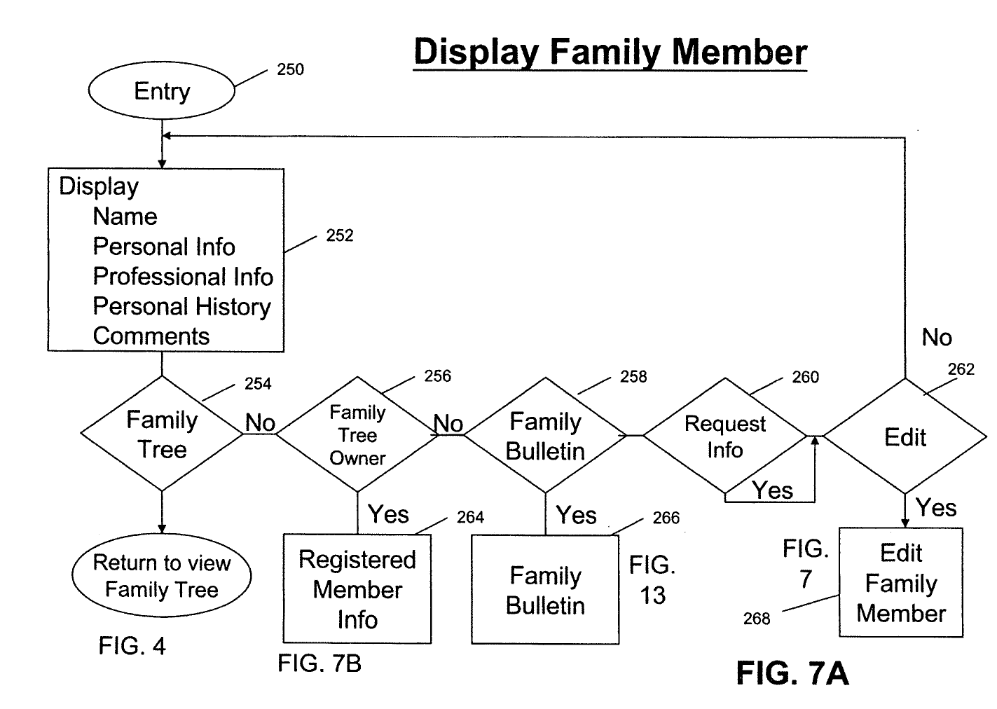

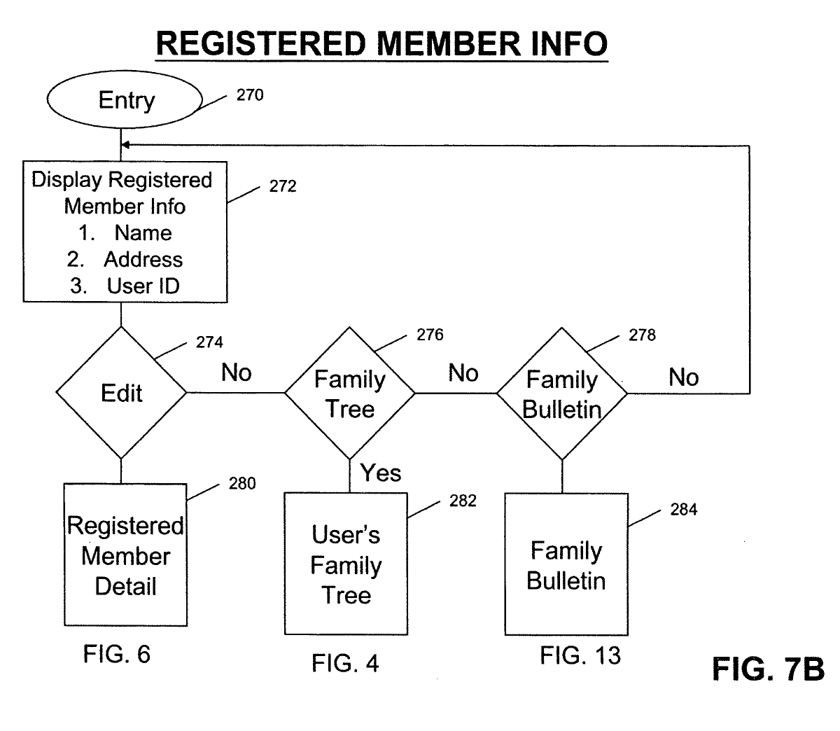

When the user selects to enter the family tree view page (140) as illustrated in FIG. 4, a family tree including name, picture and/or location is displayed (142). Family member data (150) may be displayed by selecting a family member (144). Also, family bulletin may be displayed (152) by selecting family bulletin (146). Further, the family tree may be printed (148, 154).

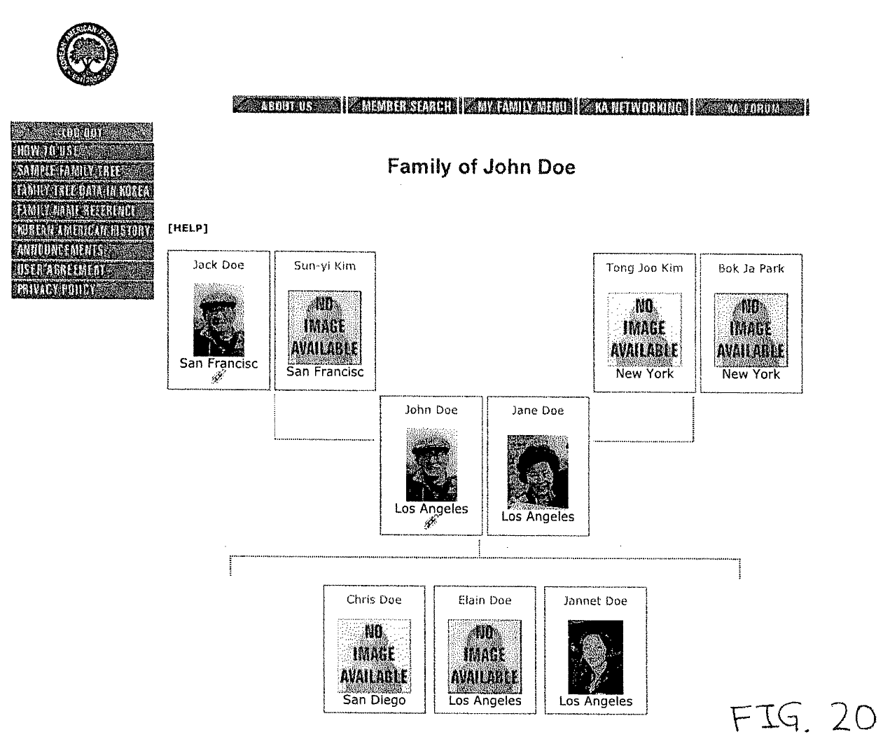

As can be seen in FIG. 20, a family tree chart is based on individual nucleus family. The family tree chart shows husband and wife, their parents and children as a unit of the family tree chart. Each family member is depicted with name and thumb-nail picture or gender specific dummy picture. User can reach certain member detailed text data by clicking the picture. User may add or edit member data from this View Family Tree edit entry if the display data are not masked.

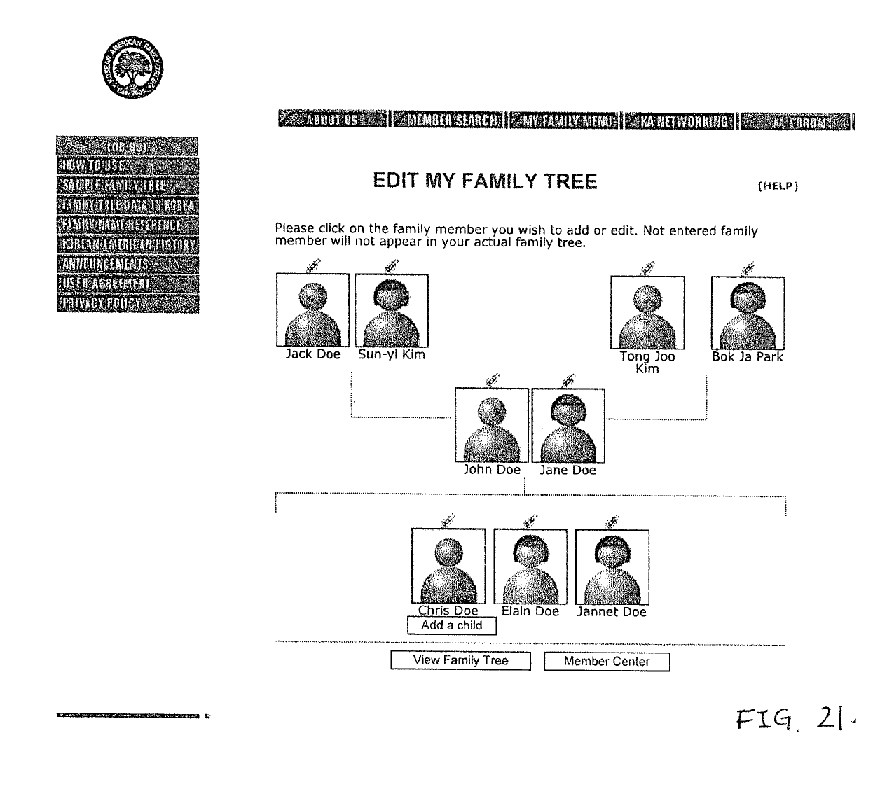

As illustrated in FIG. 5, the family tree may be edited by entering the family tree edit page (160). The family tree edit page may include a family tree display (162) with status of data entry, member name and gender, for example. FIG. 21 shows a web page for editing family tree in one exemplary embodiment according to the present invention.

The user may edit member information (164) by filling in a personal information form, which is displayed (172) for example, and the process for which is illustrated in FIG. 7, for example. After filling in the form, the personal data for the selected member may be updated (180, 186). The user may also elect the remove (182, 188) or reset (184, 190) personal data.

The user may display family tree (166, 174) instead of or in addition to editing member data. A child may be added by entering child's position and personal information (168, 176). Also, a particular member may be linked to other family tree (170, 178). Also, a registered member main page may be accessed (see FIG. 3, for example) Each family member can have a link to another nucleus family tree, for example, linking to parent's family tree or children's own family trees. Through the linking process, multiple nucleus family trees may be linked together to create a larger family tree network.

The nucleus family linking process may be prepared by a) Invite, b) Approve, c) Block, and d) Cancel by the two linking families through, for example, a) Manage Tree Access List, b) Access Request and/or c) Invitation keys. In a particular embodiment, actual link may be generated, for example, when a member clicks a link button at “Edit My Family Tree” page. As for view, if user clicks the link button (e.g., the link button # at the View Family Tree Window), the other family tree will be displayed. The nucleus families may be linked upward, downward, left or right direction by clicking the link button. Families may be linked even if the families are not genealogically direct lineage.

The linking process in one exemplary embodiment is as follows.
1) If a member from Family “A” wishes to link to another member, he/she can do so by going to the “Edit My Family Tree” page (See FIGS. 5 and 21, for example). Then click the link flag (a # sign on the top of the member's picture) above any member within his/her family tree as can be seen in FIGS. 20 and 21, for example.
2) The “Link Family Tree” page may then appear. The member from Family “A” can then type in the User ID of the owner of the Family that he/she wishes to link to. If the link is successful, a “Link was successful” message may appear. If a link has already existed, a name may appear in the User ID space when user clicks the link flag.
3) In order to view the linked family tree, the member/user may either request to view that family's family tree, or invite others to view his/her family tree.
4) User may now view the linked family tree by clicking the link icon below the picture of any applicable family member in the “View My Family Tree” page (See FIGS. 4 and 20, for example). For example, the link icon is shown near the bottom of the picture box labeled “Jack Doe.”

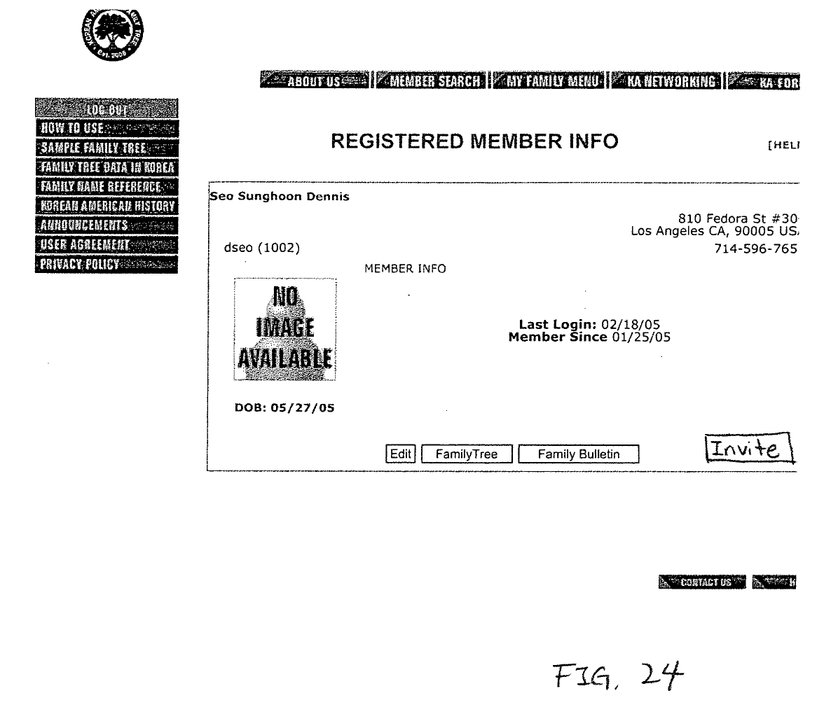

The invitation process in one exemplary embodiment may be as follows.
1) A member from Family “A” types in the User ID of a member from Family “B” (e.g., Family of Peter Lee) in the invitation box in the “Registered Member Main” page (See FIGS. 3 and 19, for example) and then press the INVITE button in order to invite member from Family “B” to view their family tree. In one embodiment, the invitation may also be done by clicking an “Invite” button in the “Registered Member Info” page (See FIGS. 7B and 24, for example).
2) Both members from Family “A” and Family “B” can see such invitation status in “My Family Tree Access Management” page (See FIGS. 3, 14 and 22A,B, for example). The member from Family “A” can cancel the invitation by clicking the “cancel” button. Also, the member from Family “B” can choose to accept or reject such invitation.
3) When the member from Family “B” accepts the invitation by clicking the accept button, e.g., by clicking a check mark, that member from Family “B” can now view the family tree of Family “A”.
4) The member from Family “A” can now see the acceptance in the “My Family Tree Access Management” page (See FIGS. 3, 14 and 22A,B, for example) that the member from Family “B” has accepted the invitation. The member from Family “A” and/or Family “B” may block an access by clicking the “block” button [symbol] as can be seen in FIGS. 22A,B, for example. By way of example, when a link is requested by other family or a link is completed, the “block” button [symbol] may be provided by the system to allow the user to block the link.

The request process in one exemplary embodiment may be as follows.
1. A member from Family “A” can request to see the family tree of a member from Family “B” by clicking a “Member Search” button and then type in the name of “B” family member and click a “Search” button. The system finds “B” name and asks what to do. When the Family “B” member is located, the Family “A” member clicks the “Tree” button which indicates the Family “A” member's option to get the Family “B” member's family tree. The Family “A” member can then click the “Request for Access” button in order to request to see personal info of the member of Family “B” from Family “A” Member Search. The message “Request for Access” will appear for the member of the Family “B” when user (the Family “A” member) tries to see the information of the member without request approval.
2. The member from Family “B” would see such request in his/her “My Family Tree Access Management” page (See FIGS. 3, 14 and 22A,B, for example). He/she can choose to approve such request or deny it.
3. The member from Family “A” may see the status of such request in he/her “My Family Tree Access Management” page (See FIGS. 3, 14 and 22A,B, for example) as well by checking if the request is approved or denied.

This way, using the described embodiment of the present invention, any Korean family can generate their own nucleus family trees and link together in a centralized database at the family tree system (e.g., KAFT.NET) web site through the Internet. Family tree member data entry, member search, family bulletin, member net working, Korean American History, and Korean American News/Forum functions together with other supporting functions may all be tied together to enhance Korean American networking in the described exemplary embodiment.

Bon-Kwan (Korean family origin names) may be introduced to clear up differences between identically spelled Korean family names.

Member privacy requirements may first be achieved by individualized User ID defined by each member. Secondly, member privacy may be achieved by member definable and changeable Password. Thirdly, privacy masking may be used. By way of example, there may be six different mapping codes, that a member can assign to mask out certain type of family member data from public view. This mapping function can be applied independently to each family member at member data entry and/or editing time by user. This may be seen in FIGS. 6, 7 and 23, for example.

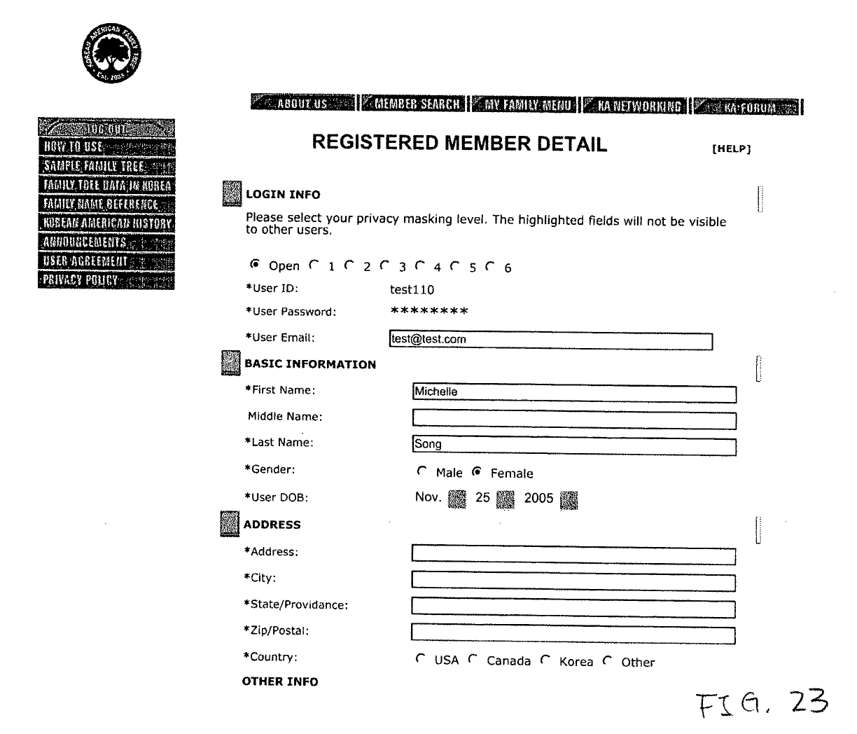

As illustrated in the flow diagram of FIG. 6, the registering member information can be updated by entering (200) the registering member detailed page, an exemplary embodiment of which is shown in FIG. 23, for example. As can be seen in FIG. 24, member information may include text and picture data and may be comprehensive enough, for future generation to see their heritage, for example. The privacy masking level may be selected from open to levels 1-6 (202) (See FIG. 23, for example); the login information may be amended (204); the name, gender and birth date may be corrected (206); the address may be updated (208); and/or other information may be amended (210). After making the changes/corrections, the member may choose update file or to return without updating (212, 214).

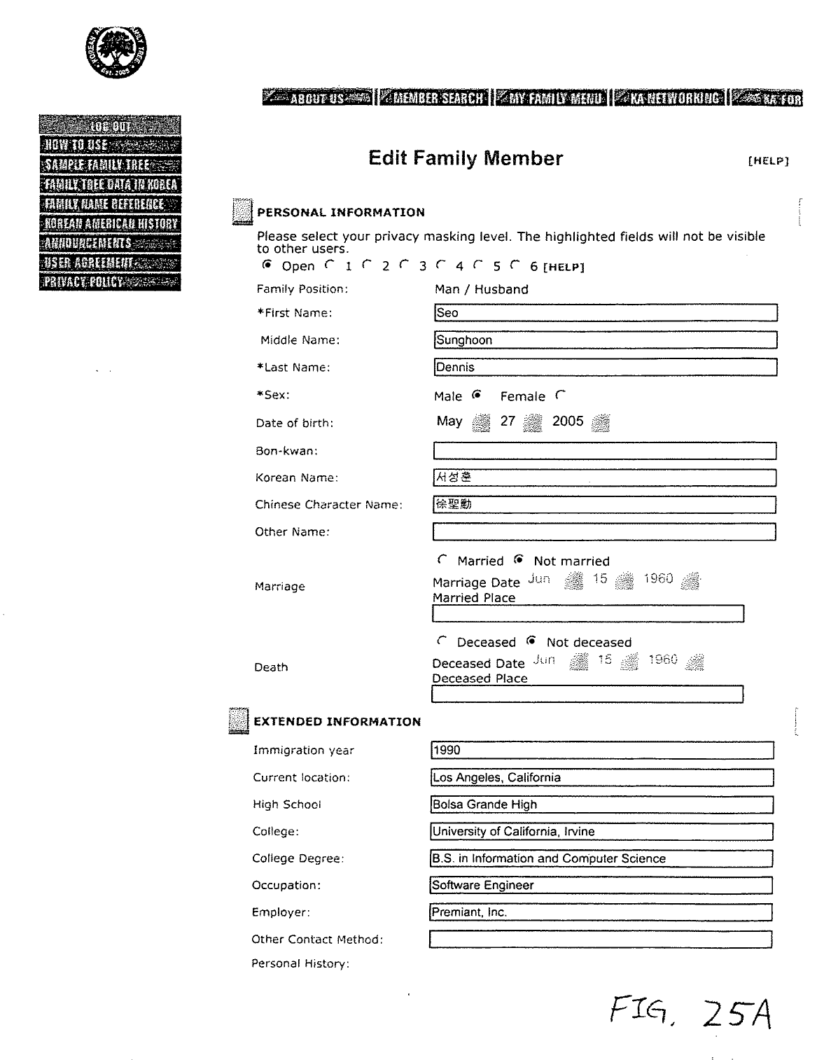

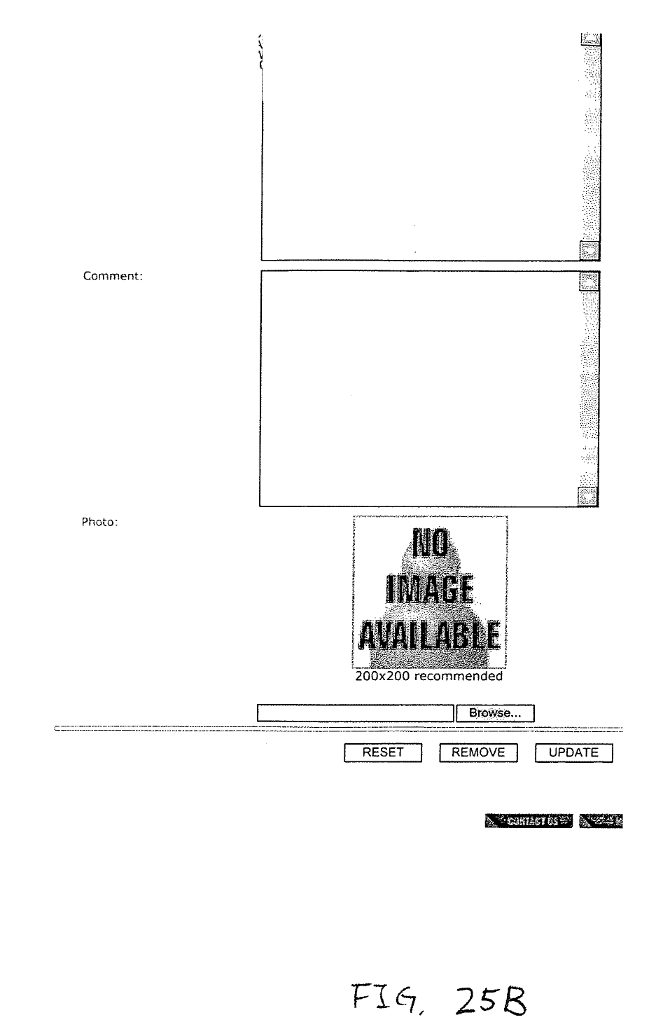

As illustrated in the flow diagram of FIG. 7, family member information may be edited by entering (220) the family member edit page. The privacy masking level ranging from open to levels 1-6 may be selected (222); and information such as family position, name, gender and birth date, Bon-Kwan, Korean and Chinese character name, other name, and/or marriage and/or death dates may be entered/updated (224). Further, such other information as immigration year, location, high school, college and degree, occupation, employer, and/or e-mail address may be entered/updated (226). Please refer to FIGS. 25A and 25B, for example.

In addition, personal history (228) and/or comments (230) may be entered/updated. The member may also browse and/or select photographs (232). After entering/updating family member information, the member may reset, remove, and/or update the entered/edited information (234, 236, 238, 240, 242, 244).

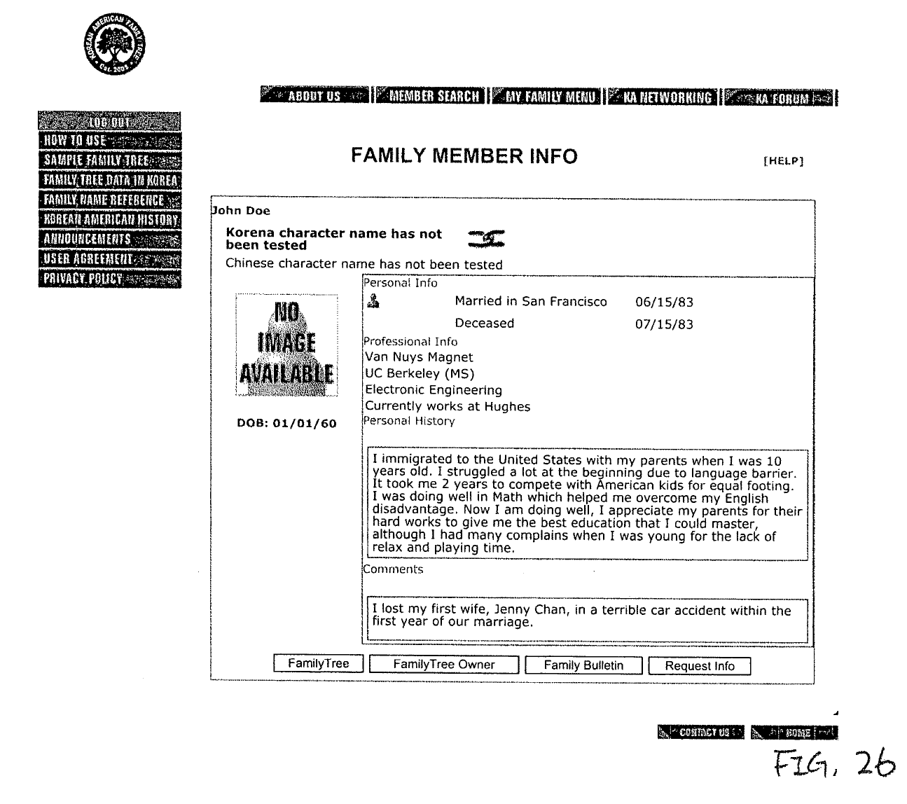

As can be seen in FIG. 7A, family member information may be displayed (250) by entering a family member information page in one exemplary embodiment as shown in FIG. 26, for example. By way of example, name, personal information, profession information, personal history and/or comments may be displayed (252). The user may elect to view the family tree (254), at which point the family tree may be viewed, the process for which is illustrated in FIG. 4, for example. Also, the family tree owner may be selected (256) to view the registered member information (264), the process for which is illustrated in FIG. 7B, for example. The user may also view the family bulletin (258, 266), the process for which is illustrated in FIG. 13, for example. Information may be requested (260), and family member data/information may be edited (262, 268), the process for which is illustrated in FIG. 7, for example.

As illustrated in FIG. 7B, the registered member information may be viewed by entering (270) the registered member information page as shown in FIG. 24, for example. Such information as name, address and/or user ID may be displayed (272). If editing (274) of information is desired, the registered member detail page (shown in FIG. 23, for example) may be accessed (280), the process for which is illustrated in FIG. 6, for example. If it is desired to view the family tree (276), the user's family tree may be viewed (282), the process for which is illustrated in FIG. 4, for example. If it is desired to view the family bulletin (278), the family bulletin may be viewed (284), the process for which is illustrated in FIG. 13, for example.

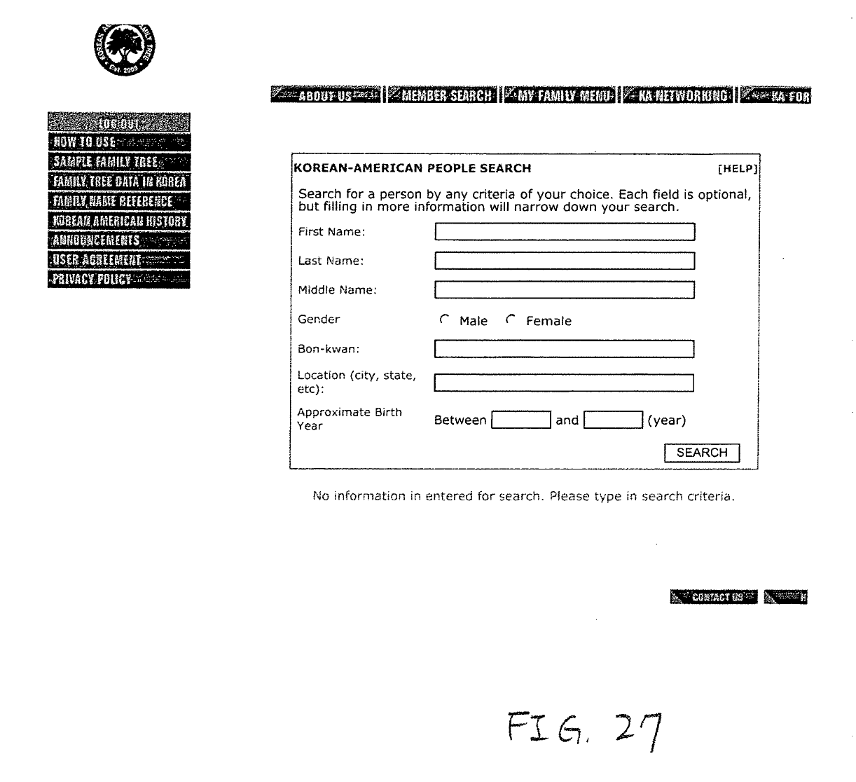

As illustrated in FIG. 8, a personal member search may be entered/performed (300). The search parameters may include one or more of, but are not limited to, first name, middle name, last name, Bon-Kwan, gender, birth year, date information, city/town, state, high school and college (302). The search page in one exemplary embodiment is shown in FIG. 27, for example. If the searched member is not found (304), no match message is displayed (306). If one or more matches are found, all of the matches/findings are displayed (308). If a person is selected (310), the database system makes a determination as to whether the member searching information is eligible to see the desired personal information (312). If the user/member is eligible, he/she may view the family tree (316). If not, the display access is denied (314).

Hence, as can be seen in FIG. 8, a family member can be searched by search function. The primary search key in the described embodiment is name. However, the first name need not be spelled all the way. If the first one or more characters entered are matched, the name is selected. Because many Korean American have identically spelled English names, many subsequent keys may be added for the search such as gender, age range, location (city and/or state), Bon-Kwan, and others as can be seen on FIG. 8, for example. When multiple members are found, the family tree system displays multiple member names for user to select one entry for display as described above.

The family tree database system in an exemplary embodiment of the present invention also includes news/forum function (e.g., Korean American (KA) news/forum function) as illustrated in FIG. 9. Once this function is entered (320), the titles of submitted stories, for example, may be displayed (321). A story may be displayed (328) by selecting a story (322). From then, the user may perform one or more of editing the story (338, 348), deleting the story (340, 350) and replying to the selected story (336, 346). The user may also write (342, 352) a story. The user/member may again wish to list (334) the stories to once again display titles of the submitted stories (321), for example.

The user/member may choose to write (324) or search (326) a story instead of selecting a story from the displayed titles. The story may be searched, for example, using author and/or key (326), and the story may be located (332). The user may write the story by entering login name and password as well as the story title (330). The user then may submit the story as an attached file (344, 354) and submit (356) and/or simply write a story file (362). The user may also reset (358, 364) to not submit the story. Further, user may click a “back to list” button to display (321, 360) the titles of the submitted stories once again.

Hence, using Korean American News/Forum function of the family tree database system, important news for Korean Americans are introduced or disseminated. Also, the family tree system (e.g., KAFT.NET) members can write their opinion in this section. General public may be allowed to view the Forum story content, but may not be permitted to write. Each news story and/or member entered story may, for example, be placed as a file with a title for a month unless the time is extended by the family tree system.

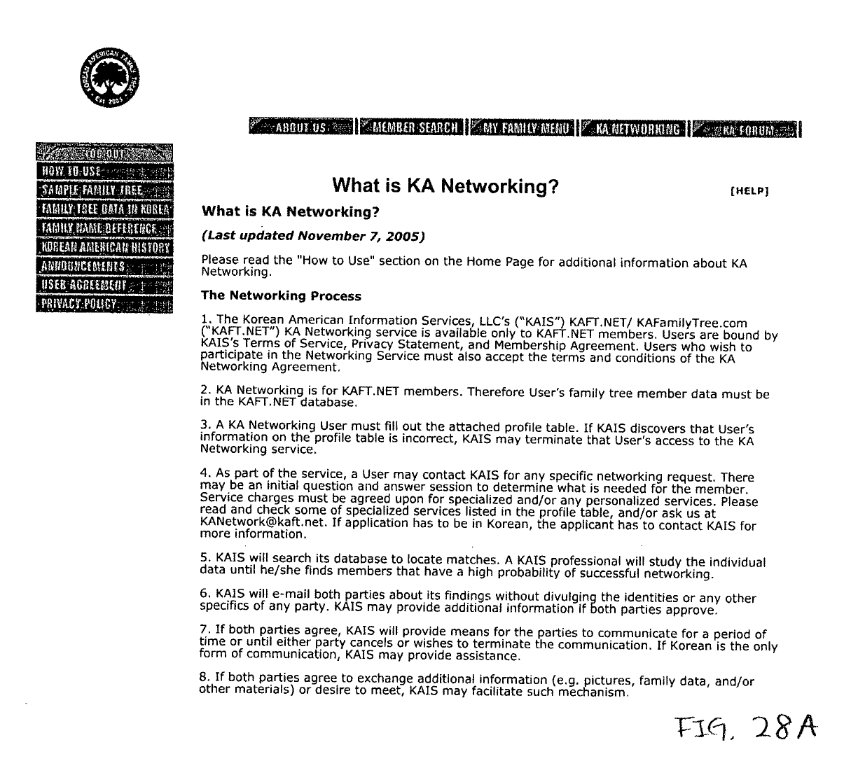

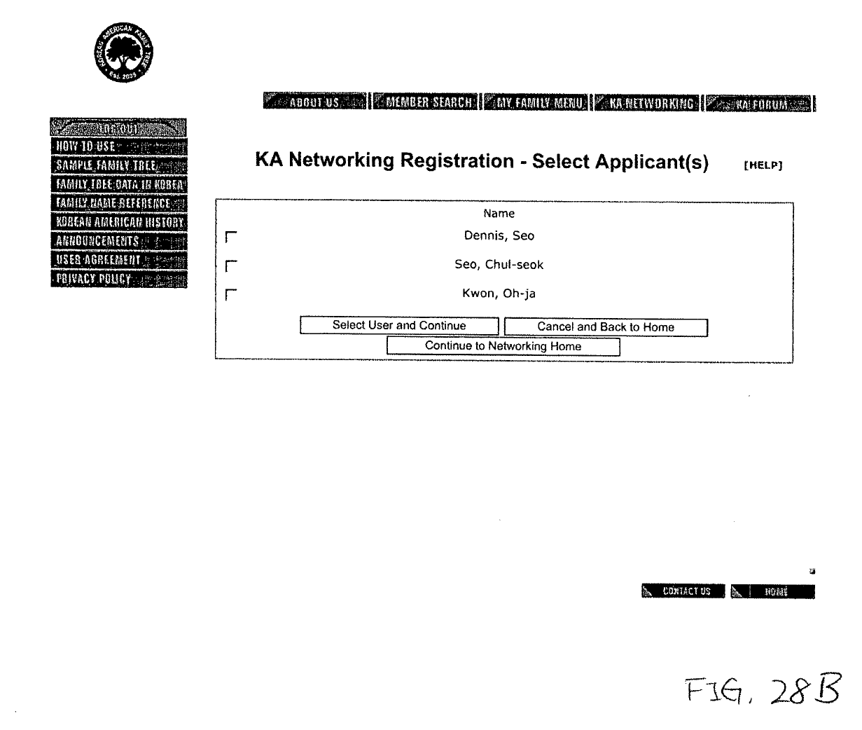

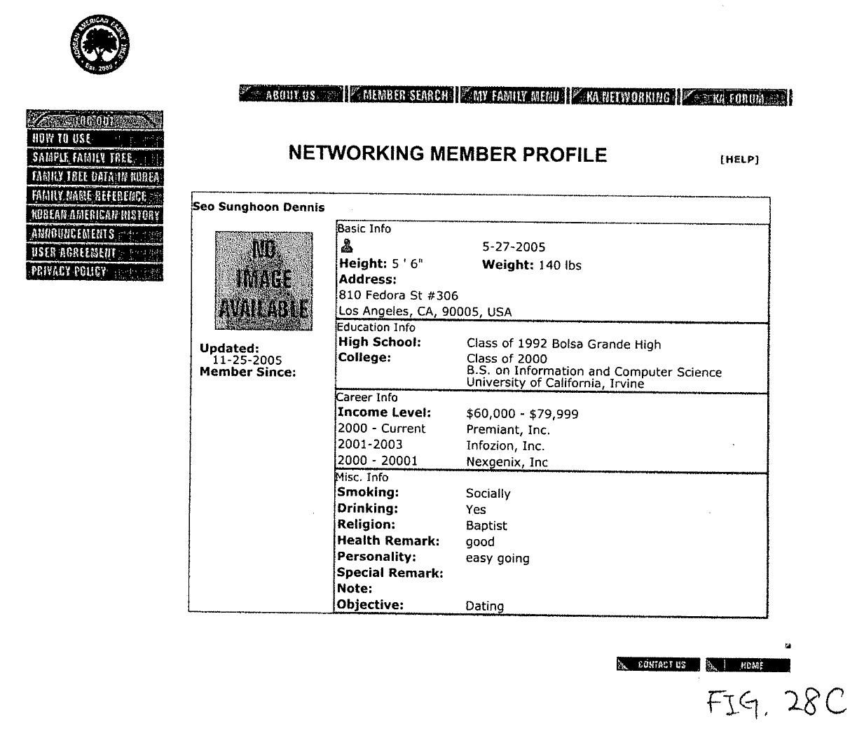

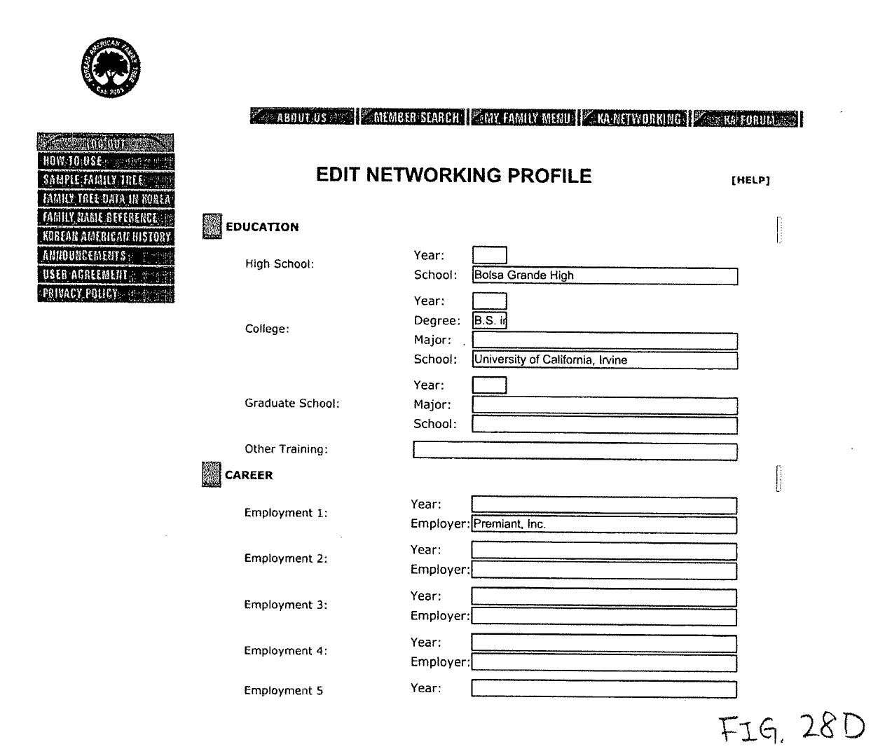

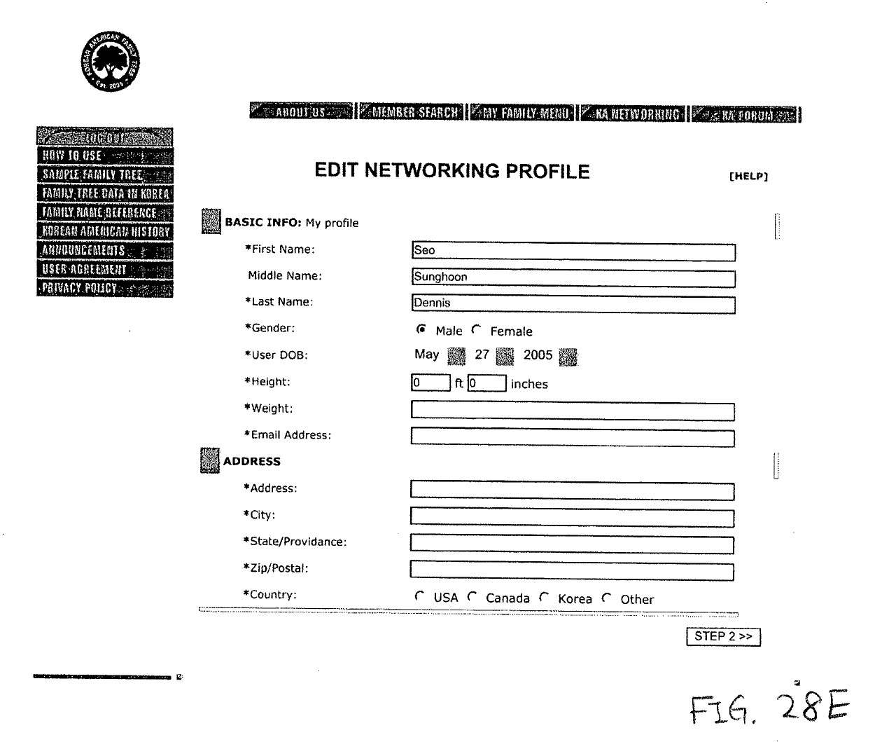

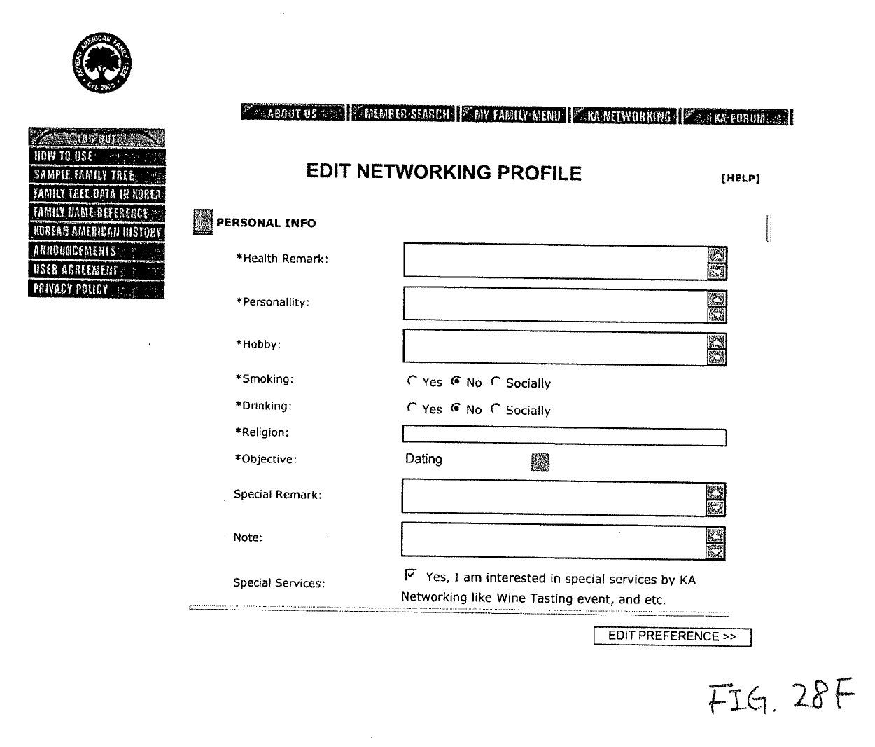

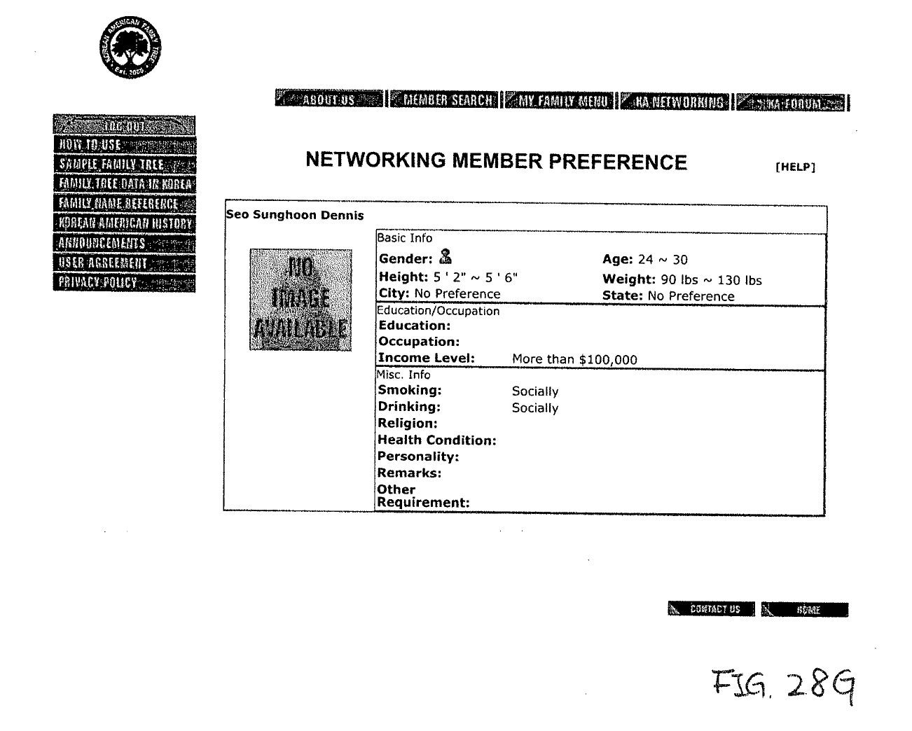

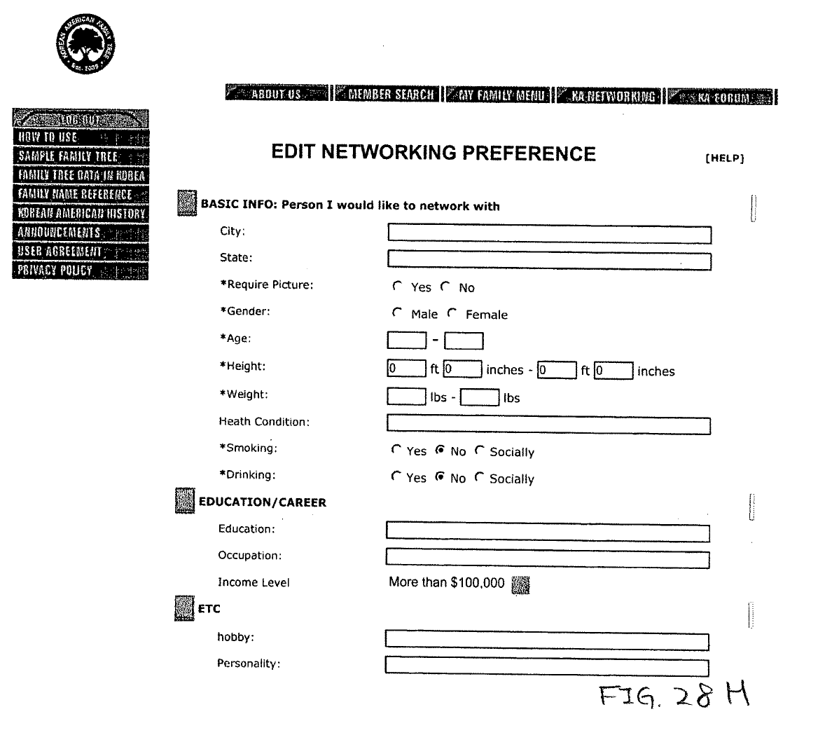

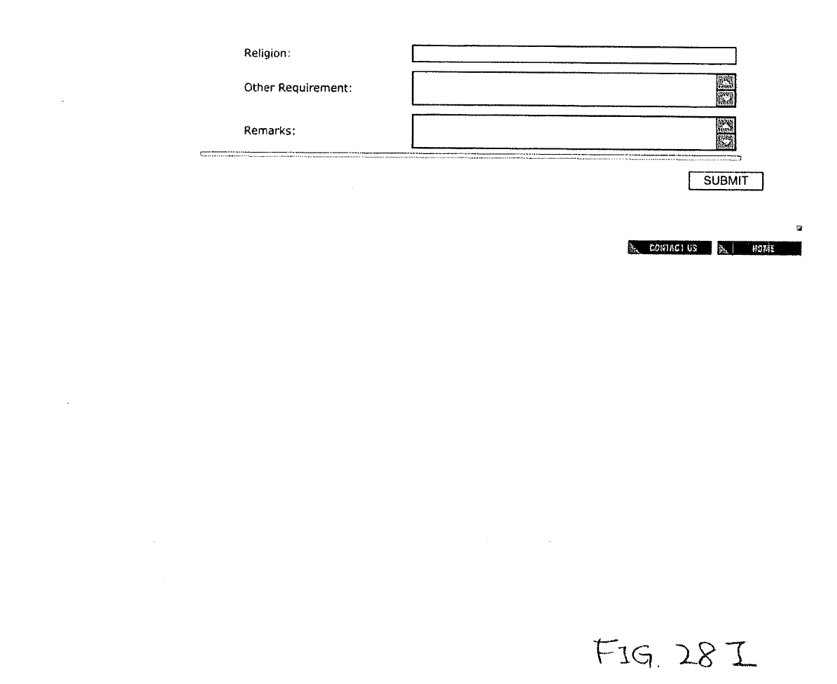

The Korean American (KA) networking process is illustrated in FIG. 10, for example. FIGS. 28A-28I, for example, are screen shots of KA networking related pages in one exemplary embodiment according to the present invention. After entering KA networking page (370), an explanation of how KA networking works may be displayed (372). If the user continues (374), the KA networking agreement may be displayed (376). After the user accepts the agreement (378), he/she submits profiles (380), which may include Profile and Preference tables. When a match is found (384), the user may choose to accept or reject the match (388). The match/accept process may also involve an offline search process (382) as well as an offline acceptance process (386).

Once accepted, the member/user may be provided with a method or means to directly communicate with the person found through the match (390). A counseling service (391), which may or may not include a professional counseling service (392) may also be provided. When the information exchange is accepted (393), the matched person may be provided an entry to the family tree (394). After this point, another counseling service (395), which may or may not include a professional counseling service (396), may be provided if the professional service is desired. If not, the process returns (see FIG. 10).

By way of example, a serious dating search may be performed as follows. Initial matching may be done through database search of profile and preference tables submitted by members. Additional search may be performed through database search of family member data. Once probable matches are found, a) some of missing information, such as educational background, may be gathered for communication to both parties. These works may be non-real time database searches and may be done by a professional such as counselor for match making.

When a group of probable matches are gathered, the on-line family tree database system of the present invention (e.g., KAFT.NET) may arrange a special party, travel plan, or professional speaker, or professional counselor who can assist the networking group members. How to organize the events may depend entirely on the members' preference. The on-line family tree database system may make these services available to members. The system of the present invention may serve as counselor to these event planning.

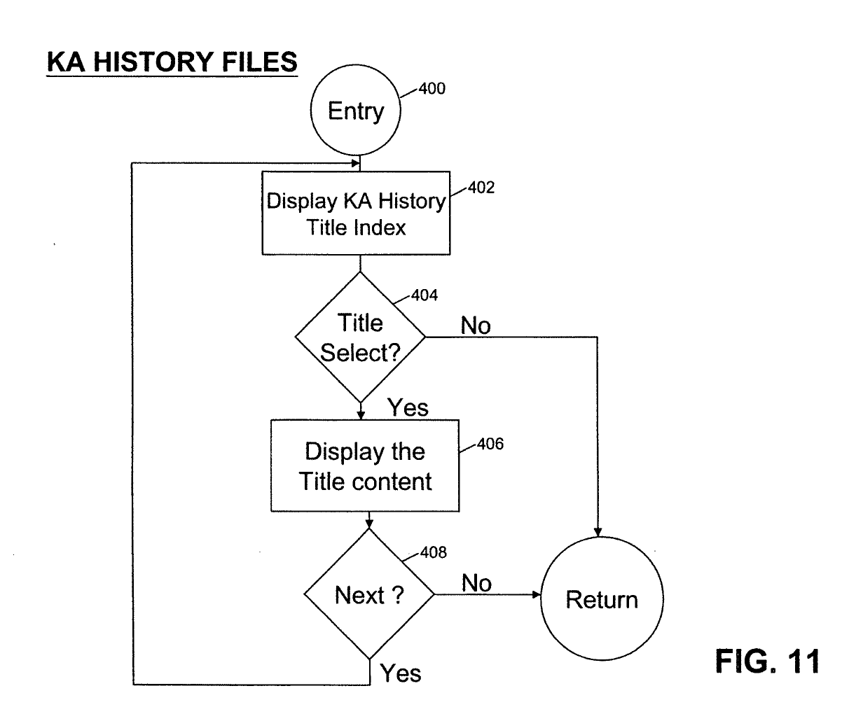

As can be seen in FIG. 11, Korean American (KA) history files may also be viewed, for example. The Korean American History function may be designed to serve members and general public alike. Each contributing content may be structured as a file. Selection of contents and the time period to keep the contents may be decided by the family tree system (e.g., KAFT.NET) editorial personnel. When the KA history page is entered (400), a KA history title index may be displayed (402). When a title is selected (404), the content of the selected title is displayed (406). Further, a next title may be selected (408) if desired by once again displaying the KA history title index (402).

FIG. 12 illustrates a login ID and password control process in an exemplary embodiment according to the present invention. Once the process is entered (420), the login ID is tested (422). If the login ID is OK (424), password is checked (430), and if the password is OK, the user/member may proceed to the family tree center to use the family tree database system. If the login ID is not OK, a new member registration process may be started (426), or in case the user/member forgot the login ID (428), the logic ID may be obtained by entering e-mail address, name, birth date and/or any other suitable, member specific information (434). Also, if the password is incorrect when checked (430) and the user/member forgot the password (432), the login ID and e-mail address may be entered (436), for example, to obtain the password from the family tree database system.

As can be seen in FIG. 13, the process of displaying/editing family bulletin is similar to the process of displaying/editing news/forum illustrated in FIG. 9. With the family bulletin function, if a family member writes and/or places a picture, the input data are stored as a file with a title. The file is viewable by family members.

Once the family bulletin page is entered (450), the titles of family bulletin files, for example, are displayed (452). A story may be displayed (460) by selecting a family bulletin title (454). From then, the user may perform one or more of writing a story (474, 484), deleting a story (472, 482), editing a story (470, 480), and replying to the selected family bulletin story (468, 478). The user/member may return back to the list (466) of the stories to once again display family bulletin file titles (452), for example.

The user/member may choose to write (456) or search (458) a story instead of selecting a family bulletin story from the displayed titles. The story may be searched, for example, using author and/or key (458), and the story may be located (464). The user may write the story by entering name and password as well as the story title (462). The user then may submit the story as an attached file (476, 486) and submit (488) and/or simply write a story file (494). The user may also reset (490, 496) to not submit the story. Further, user may return back to (492) list the titles of the family bulletin files/stories.

As can be seen in FIG. 14, the user/member's family tree access may be managed. A screen shot of the family tree access management page in one exemplary embodiment is shown in FIG. 22A,B, for example. Upon entering (500), a friends' family tree display status (502) may be viewed. In the friend's family tree display table, the status of one or more friends' family trees toward my family tree may be listed. The user/member may request to access or sign on to one or more family trees of friends (506). Upon receiving approval of such sign on, the user/member may sign on or access the approved friend's family tree. One or more of the friends' family tree access in the friends' family tree table may be deleted (508, 518) by the member/user.

The user/member's family tree access display status may also be viewed (504) in the family tree access management page of FIG. 22A,B. The user/member can invite one or more friends or acquaintances (e.g., members of other family trees) to request access to the user/member's family tree (510) and an invite message may be displayed (520) in both the user/member's Access Management page and the invited friend's Access Management page (e.g., see FIGS. 22A,B). If the invitation is approved (512), the approve message may be displayed in both the user/member's Access Management page and the invited friend's Access Management page (522). Alternatively, the user/member may block the message (514, 524) from one or more friends (e.g., members of other family trees). The block button may be turned on when a) someone makes a request to see a member's family tree, and b) access to see that member's family is approved for that someone. The block button may be used to allow the member to block that someone's access to the member's family tree when need arises.

As can be seen in FIG. 15, an access request may be entered (530). The requesting information can be viewed (532), and the requester can be displayed (540), the process for which may be illustrated in FIG. 7B. The request for access to the user/member's family tree may be approved (534, 542), blocked (536, 544) or deleted (538, 546). FIG. 15 shows the “ACCESS REQUEST” table at the Register Member Main page (FIG. 19). If someone else has access to the member's family tree, that request is shown in the ACCESS REQUEST with option buttons for Approve [symbol] , Block [symbol] , and Delete [symbol] .

The KAFT.Net membership agreement process is illustrated in FIG. 16. Once entered (550), the purpose and what is needed for the agreement are displayed (552). If user ID is not found (554), an error message is displayed (556). If the user ID is found, payment may be made by credit card (558), check (572) or any other suitable method (574). If payment cannot be made, an error message is displayed (576). For the credit card payment (558), credit card number (560) and expiration date (564) are needed. If either the credit card number or the expiration date are not correct or not entered, respective error messages are displayed (562, 566). If the payment is accepted (568), the registration is complete and the payment data is saved (570).

In one exemplary embodiment, in order to have a list of “Access Request” in the “Registered Member Main (my family menu)” as can be seen in FIG. 19, someone needs to visit the member's family tree and press “Request” button for access. Further, in the described embodiment, if someone invites a member through the invitation box, it will appear in “invitation” list in the Registered Member Main page.

In “My Family Tree Access Management” page as can be seen in FIGS. 22A and 22B, the status of the family tree a member can visit (e.g., “My Friends' Family Tree”) is shown on the left side. In other words, it is the list of people that the member can visit. On the right side is the “My Family Tree Access List” that shows the list of people who have made requests and manages list of people who may be able to see the member's family tree. In other words, it is the list of people who can visit the member.

While certain exemplary embodiments have been described above in detail and shown in the accompanying drawings, it is to be understood that such embodiments are merely illustrative of and not restrictive of the broad invention. It will thus be recognized that various modifications may be made to the illustrated and other embodiments of the invention described above, without departing from the broad inventive scope thereof. In view of the above it will be understood that the invention is not limited to the particular embodiments or arrangements disclosed, but is rather intended to cover any changes, adaptations or modifications which are within the scope and spirit of the invention.

By way of example, while the specific embodiments described herein are directed to such a family tree/genealogy system for Korean-American families, it is broadly applicable to any family tree/genealogy system for any group of people, such as ethnic groups, nationalities, religious groups, etc.

Further, while the embodiments in the specification and the drawings are described in reference to using English for the family tree system and method, the on-line family tree database system of the present invention is not limited to using English only. By way of example, in one embodiment, Korean language input may be accepted instead of or in addition to the English input, and Korean language output may be provided instead of or in addition to the English output. For example, if a member set up East Asian language input mechanism, then the member can input Korean, Japanese or Chinese (but not limited thereto). Mixing one or more of these languages together with English may be allowable in one embodiment.

What is claimed is:

1. An on-line family tree database system comprising:
one or more family trees, each family tree including one or more members, the family trees being linkable to each other to form a family tree network, wherein the system allows said one or more members of each family tree to selectively link to other said one or more family trees; and
a database of one or more files that are pertinent to the members of the family trees according to at least one of ethnicity, religion or culture.

2. The on-line family tree database system of claim 1, wherein each family tree includes personal information of the one or more members, and wherein the system allows the one or more members of the family trees to selectively mask personal information so as to assure privacy.

3. The on-line family tree database system of claim 1, wherein the database of one or more files includes at least one of history, family name reference and genealogical information pertaining to Korean Americans.

4. The on-line family tree database system of claim 1, wherein each family tree has an associated family bulletin for storing messages submitted by its one or more members.

5. The on-line family tree database system of claim 1, wherein the system provides a forum for the one or more members of the family trees to post and/or read stories.

6. The on-line family tree database system of claim 1, further comprising networking means that enable the members of the family trees to network with each other.

7. The on-line family tree database system of claim 6, wherein said networking means comprises searching means that enable the members to search other said one or more members.

8. The on-line family tree database system of claim 1, further comprising means for the members of one of the family trees to invite the one or more members of other said one or more family trees to link to the one of the family trees.

9. The on-line family tree database system of claim 1, further comprising means for the members of one of the family trees to request the one or more members of other said one or more family trees to allow linking between the one of the family trees and the other said one or more family trees.

10. The on-line family tree database system of claim 1, wherein each family tree includes personal information of the one or more members, the personal information including Bon-Kwan (family origin name).

11. A method of creating a family tree network in a family tree database system, comprising:
creating a family tree; and
selectively linking the family tree to one or more other family trees.

12. The method of claim 11, wherein said linking the family tree comprises inviting a member of said one or more other family trees to link to the family tree.

13. The method of claim 11, wherein said linking the family tree comprises requesting to a member of said one or more other family trees to allow the family tree to link to.

14. The method of claim 11, wherein creating the family tree comprises entering personal information of a member, the method further comprising selectively masking the personal information so as to assure privacy of the member.

15. The method of claim 11, further comprising networking with members of other family trees.

16. The method of claim 11, further comprising submitting stories pertinent to members of the family tree to a family bulletin of the family tree database system.

17. The method of claim 11, further comprising submitting stories pertinent to Korean Americans to a forum of the family tree database system.

18. A family tree database system comprising:
means for creating a family tree comprising one or more members; and
means for selectively linking the family tree to one or more other family trees.

19. The family tree database system of claim 18, wherein personal information of the members is entered during the creation of the family tree, the system further comprising means for selectively masking the personal information so as to assure privacy of the members.

20. The family tree database system of claim 18, further comprising at least one of means for requesting to view the one or more other family trees, means for inviting a member of the one or more other family trees to view the family tree, means for linking to genealogy in one or more other countries, or means for using history in the U.S. of people having a particular national heritage.
